(19) United States
(12) Patent Application Publication
(10) Pub. No.: US 2012/0116897 A1
(43) Pub. Date: May 10, 2012

(54) System and method for propagating interactive online advertisements

(75) Inventors: Theresa Klinger, Alamo, CA (US); Ariel Wada, Larkspur, CA (US)

(73) Assignee: Pure Verticals, Inc.

(21) Appl. No.: 13/068,386

(22) Filed: May 9, 2011

Related U.S. Application Data
(63) Continuation-in-part of application No. 12/459,447, filed on Jun. 30, 2009.
Application No. 12/459,447 is a continuation-in-part of application No. 12/459,438, filed on Jun. 30, 2009.
Application No. 12/459,447 is a continuation-in-part of application No. 12/456,899, filed on Jun. 22, 2009.
Application No. 12/456,899 is a continuation-in-part of application No. 12/381,603, filed on Mar. 13, 2009.
Application No. 12/381,603 is a continuation-in-part of application No. 12/291,207, filed on Nov. 7, 2008.
Application No. 12/291,207 is a continuation-in-part of application No. 11/968,374, filed on Jan. 2, 2008.
Application No. 12/459,438 is a continuation-in-part of application No. 12/456,899, filed on Jun. 22, 2009.
Application No. 12/456,899 is a continuation-in-part of application No. 12/381,603, filed on Mar. 13, 2009.
Application No. 12/381,603 is a continuation-in-part of application No. 12/291,207, filed on Nov. 7, 2008.
Application No. 12/291,207 is a continuation-in-part of application No. 11/968,374, filed on Jan. 2, 2008.
Application No. 12/456,899 is a continuation-in-part of application No. 12/313,423, filed on Nov. 19, 2008.
Application No. 12/313,423 is a continuation-in-part of application No. 11/968,384, filed on Jan. 2, 2008.
(60) Provisional application No. 60/989,430, filed on Nov. 20, 2007.
(60) Provisional application No. 61/043,897, filed on Apr. 10, 2008.

(51) Int. Cl. G06Q 30/02

(52) U.S. Cl. 705/14.73

(57) ABSTRACT

A system for enabling interactive online advertisements, comprising a merchant interface software adapted to receive requests over a network, an advertising server software coupled to one or more networks, a shopping cart software adapted to receive requests over a network, is disclosed. According to the embodiment, the merchant interface receives requests from a plurality of merchants over a network to upload one or more advertisements to the advertising server, and the merchant interface receives requests from a plurality of merchants over a network to place product-related information at specific points in time within an advertisement, and, upon receiving requests for uploading an advertisement and for placing product-related information at specific points in time within the advertisement, the advertising server creates an interactive online advertisement wherein, when a user views a web page with which the interactive online advertisement has been associated, the user is provided with a the advertisement for viewing and, at the specific points in time within the advertisement, the product-related information is provided to the user, and, upon receiving a request from a user viewing an interactive online advertisement to place a product about which product-specific information has been provided, the shopping cart server software adds a desired quantity of the product into the user's shopping cart, without the user having to leave the page or the interactive online advertisement within which the user was able to view the product-specific information.

### CROSS-REFERENCE TO RELATED APPLICATIONS

The present invention is a continuation-in-part of U.S. patent application Ser. No. 12/459,447, titled “System and Method for Propagating Endorsements”, filed on Jun. 30, 2009, and is a continuation-in-part of U.S. patent application Ser. No. 12/459,438, titled “System and Method for Analyzing Endorsement Network”, each of which is a continuation-in-part of U.S. patent application Ser. No. 12/456,899, titled “Method and System for Monetizing Content”, which is a continuation-in-part of U.S. patent application Ser. No. 12/381,603, titled “Method and System for Monetizing Content”, filed on Mar. 13, 2009, which is a continuation-in-part of U.S. patent application Ser. No. 12/291,207, titled “Method and System for Monetizing Third-Party Content”, filed on Nov. 7, 2008, and is a continuation-in-part of U.S. patent application Ser. No. 11/968,374, titled “Method and System for Monetizing User-Generated Content”, filed on Jan. 2, 2008, and claims priority to Provisional Application Ser. 60/989,425, filed on Nov. 20, 2007. The disclosure of each of the above-referenced patent applications is hereby incorporated by reference in its entirety.

The above-referenced invention (12/456,899) is also a continuation-in-part of U.S. patent application Ser. No. 12/313,423, titled “Method and System for Linking EProcurement to Virtual Communities”, filed on Nov. 11, 2008, which is a continuation-in-part of U.S. patent application Ser. No. 11/968,384, filed on Jan. 2, 2008, and claims priority to Provisional Application Ser. 60/989,430, filed Nov. 20, 2007 and Provisional Application Ser. 61/043,897, filed Apr. 10, 2008. The disclosure of each of the above-referenced patent applications is hereby incorporated by reference in its entirety.

### BACKGROUND OF THE INVENTION

1. Field of the Invention

The present invention is in the field of ecommerce and to electronic advertising, particularly as they pertain to the provision of interactive online advertisements with integrated ecommerce functionality.

2. Discussion of the State of the Art

In the field of entertainment media, several trends have emerged in recent years, quite separately, that when combined offer surprising new possibilities for individuals and enterprises alike. One of these trends is emergence of product placements as a new kind of advertisement. This now familiar technique involves advertisers (vendors of products such as personal computers, cars, liquors and toys, just to name a few) paying content creators (movie studios, TV studios and others) to display or refer to their products in prominent ways within the content itself. This is in stark contrast to previous practices in advertising, where the boundary between advertising and entertainment content was clearly defined; with product placements, commercial messages can be included within content for which consumers pay to view, and with which consumers are strongly emotionally engaged.

A second trend is democratization of content creation. In the age of the great movie studios, control of content creation (at least in the new media of radio and the movies) was entirely within the hands of a few very powerful businessmen. Later, as the costs of high quality production came down, and as more and more channels to market became available, first through UHF television stations and later through cable and satellite systems, content creation became more diffuse, taking place across thousands of companies acting in various capacities. But only recently has serious content routinely been created by individuals acting as consumers rather than as employees of media companies. The emergence of “user-generated content” (UGC) has been a large part of the post-2000 boom in user-centric web services, which commonly is labeled broadly as Web 2.0. Today, with blogs, personal web pages, and sites for the uploading of user-generated music and video clips, more and more of what people read, hear and watch is created outside of the corporate world and in the world of UGC.

Another important trend has been emergence of highly targeted advertising. Advertising once was a mass media affair, and segmentation tended to go no further than choosing during which radio or television shows to advertise. Today, Internet portal companies, search engines, marketing database companies with access to credit card and other financial data all compete to precisely target advertisements to ever more finely sliced segments of the consumer population. The rapid rise of Google has also shown how much the advertising equation has changed; while charging only a tiny fraction of what traditional media charged for advertising, and while permitting only the most rudimentary text-based advertising, Google has grabbed a significant share of the advertising market and has built a highly profitable business, because its ad placements are highly targeted and because advertisers only pay when ads are clicked.

Finally, the last few years have seen emergence of another new category of web-based entity, the virtual community. A well-known emerging category of virtual community is social networks. Already there are thousands of these, ranging from the very large operators such as MySpace or Facebook to very small, highly verticalized players. There are even companies selling platforms for launching new social networks quickly and inexpensively. And social networking has quickly become one of the major outlets for user-generated content (in fact, one can view each subscribers profile page as a form of UGC). As is typical in web trends, the original social networking pioneers offered “something for nothing”, and most social networking sites continue to offer a wide range of free services. But soon after, people began seeking ways to develop profitable business models to monetize the large numbers of loyal users that had been created in a very short time. Much as Google did in search, these pioneers are looking to advertising to satisfy the need to generate revenue from highly visited social networking sites, and they are typically adopting the methods used by Google—allowing users to provide advertisers access to their profile pages in return for a small slice of the advertising revenue. This is by now a well-understood business model—the site operator, the user whose profile page is used, the media buyer and others each take a piece of the total advertising spend committed by the advertisers (these by and large are the same kinds of companies as in all of the previous ages plus the new web-based companies).

Beyond social networks, other forms of virtual communities have become commonplace in the art. Among these are online gaming communities in which large numbers of individuals cooperate and compete in network-hosted gaming systems. Many of these are typified by games that are indefinite in nature, and it is common for complex social structures similar to social networks to arise intentionally or merely as a result of actions taken by many people in pursuit of their goals. Many online gaming communities include a strong element of user-generated content, with similar challenges and opportunities for monetization of this content. Other forms of virtual communities typified by widespread adoption and propagation of user-generated content, and the concomitant need for means to monetize that content, include “virtual worlds” and file sharing communities. All of these are merely exemplary of a strong shift away from static content to user-generated content in the online world, and these examples should not be considered to be limiting for the purposes of the present invention. All virtual communities in which user-generated content plays a prominent role provide background for, and will benefit from, the present invention.

Additionally, a vigorous new e-commerce market category has emerged recently commonly referred to as content aggregators. These sites, which resemble virtual communities and may be considered a subset of that category, allow users (whether individual consumers, boutique content creation companies, or major media outlets) to upload content that can then be searched and viewed freely by users of the content aggregator sites. Importantly, these sites generally also provide rich functionality for tagging, rating and commenting about content by any and all users. These sites are actively experimenting in methods for monetizing their sites, generally by placing ads on their page that are targeted based on the content viewing selections of individual users or groups of users. Additionally, these sites have enabled the embedding of advertising within the content on their sites, such as at predefined insertion points (or times) in streaming videos. In the art at the time of the present invention, the methods known to the inventors all involve the selection of advertisements for insertion by the content aggregator or a partnered advertising network.

Another problem in the art is that the interests of advertisers, content aggregators, and site operators are not well aligned. In “traditional” web advertising, each advertisement represents at once both a revenue source for the site operator and content provider (providing a way to monetize traffic generated when a site is popular), and an effort on the part of the advertiser to grab the attention of viewers and thereby to cause them to leave the page by clicking on the advertisement and proceeding to a carefully selected “landing page” controlled by the advertiser. Thus while the advertiser depends on the quality and kind of the online content to bring specific groups of viewers to a site, it then seeks to “rob” the site of its users by inducing them to leave. While this may seem to be advantageous to the advertiser at first glance, in fact it has drawbacks for the advertiser as well. After all, what the advertiser really desires is conversion: advertisers seek to convert “eyeballs” (advertisement views by users) into dollars (purchases made by those users). Ideally, conversion should be possible with minimum effort on the part of the purchasing users. The first fifteen years of online advertising has been based around the concept of leading viewers away from their current location to pages or content controlled by the advertiser, and this is seldom questioned. But if viewers could be converted to purchasers without having to leave the content that drew them in the first place, and without disrupting their flow of attention, users will be able to have a richer, less disruptive online experience while advertisers would enjoy higher conversion rates without competing with their partners (those who provide them online locations for advertising).

A simple analogy will make the difference clear. In physical retail stores such as grocery stores, it is commonplace to provide a large selection of items suitable for impulsive buying in locations where consumers will see the items just before they check out at a point of sale. For example, candy, pain relievers, magazines, and other small items are usually stocked in checkout lines, in order to encourage their purchase via impulse buying. But if instead of physical items that can be dropped into a shopping cart and purchased along with the groceries already in the shopping cart, stores were to stock a large number of advertisements which focused on inducing consumers to drop what they are doing, leave their carts behind, and proceed to a physical location specified by the advertiser, who had a staff of sales people waiting for the consumers that responded to the advertisements and ready to sell them the advertiser's wares. Such a scenario is implausible in the extreme in the physical world, but it is the norm in the online world.

What is clearly needed in the art is a way to bring together the worlds of advertising, virtual communities, and content aggregation in a way that serves the best interests of all of the key constituents—those who wish to advertise, those who wish to monetize their content, those who aggregate content from others, those who manage virtual communities, and those to whom advertisements are directed. Users of virtual communities, should they be able to influence what is advertised to them, and when and how it is advertised to them, would be able to achieve the reasonable goal of having ads that address their particular needs and preferences, at a particular point in time or generally, and to share in the benefits thus created. And, in a continuation of the trend away from mass advertising that the search-based ad illustrates, advertisers would be able to precisely target content at those virtual networks that are most predisposed to favorably react to the message, and to do so at a remarkably low cost thus driving revenue per ad dollar up dramatically. Content creators would be able to enjoy much greater and more targeted revenue-generating distribution channels, and content aggregators would be able to greatly expand their opportunities for monetizing user-generated content (UGC) that is hosted on their sites.

It is an aim of the present invention to provide a system and a method for monetizing the user-generated content that dominates virtual community sites, and to provide advertisers a method to “ride the user-generated content” wave in order to achieve improved levels of targeting specificity and return on investment. It is a further aim of the present invention to provide a system and method for monetizing third-party content by enabling endorsing users to select third-party content for display on pages or sites they control, to select products or services they wish to endorse, and to associate their endorsements with the third-party content.

### SUMMARY OF THE INVENTION

In a preferred embodiment, a system for enabling interactive online advertisements, comprising a merchant interface software adapted to receive requests over a network, an advertising server software coupled to one or more networks, a shopping cart software adapted to receive requests over a network, is disclosed. According to the embodiment, the merchant interface receives requests from a plurality of merchants over a network to upload one or more advertisements to the advertising server, and the merchant interface receives requests from a plurality of merchants over a network to place product-related information at specific points in time within an advertisement, and, upon receiving requests for uploading an advertisement and for placing product-related information at specific points in time within the advertisement, the advertising server creates an interactive online advertisement wherein, when a user views a web page with which the interactive online advertisement has been associated, the user is provided with a the advertisement for viewing and, at the specific points in time within the advertisement, the product-related information is provided to the user, and, upon receiving a request from a user viewing an interactive online advertisement to place a product about which product-specific information has been provided, the shopping cart server software adds a desired quantity of the product into the user's shopping cart, without the user having to leave the page or the interactive online advertisement within which the user was able to view the product-specific information.

### BRIEF DESCRIPTION OF THE DRAWING FIGURES

FIG. 1 is a block diagram of components of the invention in one embodiment, highlighting different roles played in carrying out the invention.

FIG. 2 is a process flow diagram of a method of the present invention.

FIG. 3 is an example of a user-generated content page illustrating how users can consume monetized user-generated content according to the present invention.

FIG. 4 is an example of a mobile phone based instance of the present invention.

FIG. 5 is another example of use of the present invention, as a means for monetized user-generated content in a multiplayer online gaming environment.

FIG. 6 is a process flow diagram of a financial transaction conducted according to an embodiment of the present invention.

FIG. 7 is a process flow diagram of a product promotion quality rating process of an embodiment of the invention.

FIG. 8 is a process flow diagram of monetization of third party user-generated content according to an embodiment of the invention.

FIG. 9 is a block diagram of an embodiment of the invention that enables the monetization of third party user-generated content.

FIG. 10 is a block diagram of an embodiment of the invention showing the relationships among the various parties involved in monetization of third party user-generated content.

FIG. 11 is an example of an endorser home page according to an embodiment of the invention.

FIG. 12 is an example of an embeddable widget according to an embodiment of the invention that allows for presentation of third party user-generated content with embedded product endorsements.

FIG. 13 is a process flow diagram of an exemplary financial arrangement conducted according to an embodiment of the invention.

FIG. 14 is an example of possible compensation or revenue share options available to the endorser.

FIG. 15 is a block diagram illustrating an embodiment of the invention using the RSS standard technology to enable the syndication of endorsements along with associated content from within a virtual community or web portal.

FIG. 16 is a block diagram of an embodiment of the invention.

FIG. 17 is a diagram showing a first step in a process of creating interactive online advertisements, according to an embodiment of the invention.

FIG. 18 is a diagram showing a second step in a process of creating interactive online advertisements, according to an embodiment of the invention.

FIG. 19 is a diagram showing a final step in a process of creating interactive online advertisements, according to an embodiment of the invention.

FIG. 20 is a diagram of an embodiment of the invention showing an interactive advertisement.

FIG. 21 is a diagram of an embodiment of the invention showing an interactive advertisement following a mouse-over event.

FIG. 22 is a diagram of an embodiment of the invention showing an interactive advertisement with related products display activated.

FIG. 23 is a diagram of an embodiment of the invention showing an interactive advertisement with a “menu on” option activated.

FIG. 24 is a diagram of an embodiment of the invention showing an interactive advertisement with all products related to an interactive advertisement displayed simultaneously.

FIG. 25 is a diagram of an embodiment of the invention showing an interactive advertisement within a virtual community web site.

FIG. 26 is a diagram of an embodiment of the invention showing an interactive advertisement within a virtual community web site after a mouse-over event.

FIG. 27 is a diagram of an embodiment of the invention showing an interactive advertisement within a virtual community web site with an interactive menu.

FIG. 28 is a diagram of an embodiment of the invention showing an interactive advertisement within a virtual community web site with related products shown.

FIG. 29 is a diagram of an embodiment of the invention showing an interactive advertisement within a virtual community web site after a user elects to close the hosting content element.

FIG. 30 is a process flow diagram of a method of the invention in which.

### DETAILED DESCRIPTION

The inventors provide, in one embodiment, a system and a method for monetization of content in which endorsers are enabled to select from a variety of products (wherever products are referred to herein, it should be understood to include not only physical products, but also virtual products such as game items for online games, and services, without departing from the scope of the present invention), from a variety of merchants, and to make them available for viewing and purchase entirely within, or associated with, their own or another's content. That is, it is an object of the present invention that endorsers are able to choose product information about products of their choosing and to embed that information, in a variety of ways, into their own or another's content. “Content” as used herein should be understood to include any content capable of being associated with arbitrary additional content, either by having the additional content embedded within it or closely associated with it at the time the content is consumed. For instance, the emergence of portable electronic readers and highly functional smartphones means that content including (but not limited to) books, audio selections, or short videos (or even feature-length movies) can be propagated to, and consumed using, these devices. Thus content, as used herein, would include an electronic book viewed offline, as long as the electronic book and the associated viewing device make it possible for endorsements to be either embedded in the book (by its publisher or by another), or to be associated with it at the time the content is “consumed” (read, in this case). Thus, the term “content” should be construed quite broadly when considering the scope of the instant invention. It is an object of this invention that viewers content that has been prepared using the instant invention will be able to view the images or information associated with the products being promoted by an endorser, and to purchase such promoted products, or to mark them for potential future purchase, as desired. It is yet another object of this invention to provide a monetary reward to endorsers and to creators of content that is used to successfully promote products for sale; it should be understood, however, that rewards other than money may also be given to endorsers, content creators and others, according to the invention. For example, “loyalty points” such as frequent flyer miles could be rewarded as a proxy for monetary reward, without departing from the spirit of the invention. Where “monetization” and “money” are used in this specification, they should be understood to mean “monetization or the like” and “money or an equivalent reward”; the form of the reward provided is not an essential element of the invention and the invention accordingly should not be limited to cases involving actual monetary transfers.

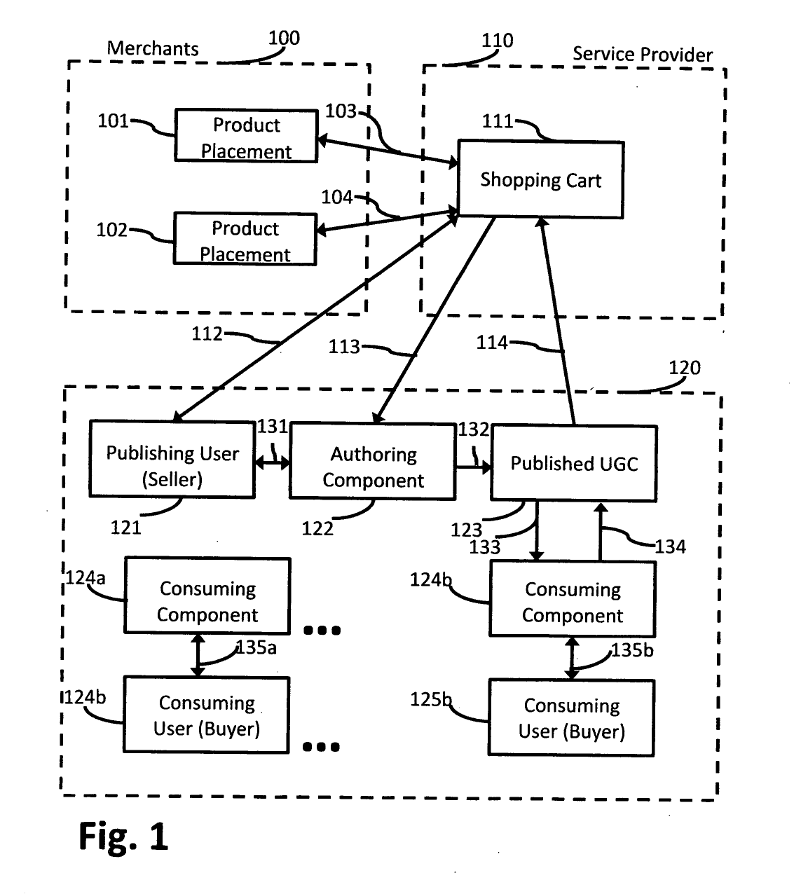

FIG. 1 is an illustration of an embodiment of the invention in which a virtual community 120 is enhanced by the provision of a universal shopping cart 111, which can be provided as a service by a service provider 110 such as a third party web services provider. The universal shopping cart 111 alternatively can be provided by the virtual community 120 itself, without the need of a third party service provider 110. The universal shopping cart 111 of the invention provides a means for merchants 100 to make product placements 101, passing product information about products that are available for sale through the virtual community 120 using interface 103 to the universal shopping cart 111, as well as a means for receiving sales transactions 102 from the universal shopping cart 111 via another interface 104. It should be noted that the interfaces 103 and 104 need not be separate, but the functions of product placement 101 and sales transactions 102 could be carried out over a single interface between the merchant's 100 systems and the universal shopping cart 111.

Virtual communities 120 are common on the Internet today, and typically provide their members (121 and 125a through 125n) with a variety of services intended to enable them to establish their own social groupings dynamically in a content-rich way. Among these services, virtual communities 120 typically provide some form of authoring component 122, where a publishing user 121 can create and edit content 131 and, when satisfied, make that content available as published UGC 123 to other users (125a through 125n) via consuming components (135a through 135n). Without loss of generality, it should be noted that in a preferred embodiment the authoring component 122 is a web page where publishing users may create and edit content 131 such as blogs, profile pages, photos, videos, personal web pages and the like. Also without loss of generality, it should be noted that in preferred embodiment the consuming components (135a through 135n) are web browsers, and the published user-generated content 123 consists of pages within a social network's 120 web site that contain the UGC 123 created by user 121 in authoring component 122.

While in an embodiment the virtual community 120 is one of the many familiar social networks available on the Internet, it should be understood that the invention can be used to market goods and services to any human network 120, for example (but not limited to) console or online gaming systems where garners create UGC 123 and the gaming industry operates the universal shopping cart 111 of the invention, kiosks where UGC is delivered to malls or stores using the method of the invention (the universal shopping cart 111 in this case could be operated by an operator of a chain of malls, or a chain of stores, or by a specialist third party who places kiosks in prominent places to allow consumption of content 123 by network members), virtual worlds where groups or entire virtual societies are formed and the universal shopping cart 111 is operated either by the host of the virtual world or by a third party service provider, or even offline networks such as groups of “friends and family” who subscribe to a value-added mobile phone service that allows users to create and post content that can be viewed on mobile phone service that allows users to create and post content that can be viewed on mobile phones, and where the mobile phone carrier or one of its partners operates the universal shopping cart 111. An important element of the invention is provision of a universal shopping cart 111 whereby members of a human network can incorporate product information from merchants 100 into their published user-generated content 123 in order to promote the sale of those products, and the fact that the consumers (125a through 125n) of the published content 123 can view product promotions and product information as an integral part of the user-generated content, and that they can purchase products or mark them for later review and possible purchase, entirely within the published content 123 via the consuming component (135a through 135n). Only when finished and ready to check out does the consuming user (now a Buyer) (125a through 125n) interact with the universal shopping cart 111, specifically by going through the shopping cart's checkout procedure.

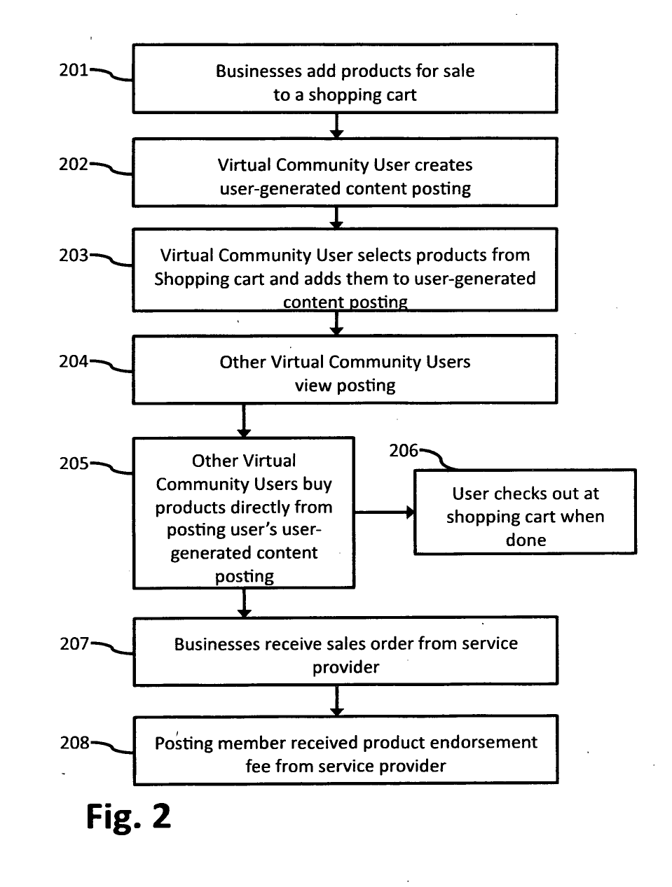

FIG. 2 outlines a method of the present invention. Preliminarily (201), businesses add products available for promotion and sale via the virtual community 120 to the universal shopping cart 111. Merchants can specify terms under which the products can be promoted and sold when adding them to the shopping cart. Clearly one of the key terms is price, which can be expressed as a fixed price or as a range of prices. In an embodiment of the invention, products can be placed in the universal shopping cart 111 for auction within the virtual community, and members of the virtual community could add that product to their content 123 and thereby accept bids; the winning bid would get the product, and the creator of the content 123 from which the winning bid was entered would receive a reward from the service provider 110 that operates the universal shopping cart 123. Businesses may also upload additional information about their products into the universal shopping cart, for example the dates when the product is available, product images, shipping costs and schedules, promotional materials in text, image or video form, and so forth. In an embodiment of the invention, merchants may specify demographic or other information about the target market of the product, although it should be clear that among the key benefits of the instant invention is the fact that it is the users who self-select by choosing what products to promote and with what people to associate; merchants implicitly are marketing to the people who associate with (network with) the people who choose their products to promote within their content 123. By making demographic and other information about who might find the product most useful, merchants are not so much targeting a market segment as they are advising those who self-select the market segment.

In step 202, virtual community members create user-generated content for posting or publishing as published content 123. As mentioned above, this step could comprise many possible actions by members of the virtual community, including but not limited to posting a blog entry, creating a video, adding content to a personal web page, updating a personal profile page, or adding a comment or essay in a public forum section of the virtual community. The virtual community member then selects products from the universal shopping cart and adds them to her user-generated content posting 203. The user actually inserts or embeds a block of code downloaded from the universal shopping cart 111 into her user-generated content 123; this embedded code block could for example be hypertext markup language (HTML), extensible markup language (XML) or the like. The code could contain a link to an image or a video, such that when a viewer of the content 123 clicks on the link they can view the image or watch the video. Such techniques are well established in the art. The embedded code can also contain means for executing a purchase or for marking an item for later review and purchase. These means could be, but are not limited to, a “Buy” button viewable by the user (“user” herein refers to the consumer (125a through 125n) of user-generated content), a “hot spot” in an image or a video which, when moused over, displays a “buy this item” tag, or other similar means.

After the creating user has created her content and added products from the universal shopping cart 111, other virtual community members view the newly published posting 204 and may optionally choose to view or buy products that are promoted in the new posting. In particular, in step 205 some virtual community members buy products directly from the posting member's user-generated content posting. The user may choose to continue viewing content 123 of the same user, or indeed may move on to other network members' content 123. This is an important advantage of the present invention: users may continue browsing the same or other users' content 123 as desired, and thereby they may accumulate several purchase decisions (or tentative decisions) before deciding to check out and complete purchases. Users can move to checkout at any time or they may be prompted, if they elect to leave the social network, to go to checkout. Optionally, a virtual community member's product selections may be kept on hold and revisited on a subsequent visit to the virtual community; this functionality is implicit in the universal shopping cart, which receives (through the mechanism of the embedded code) a notification each time a user selects a product for viewing or purchase and can store this information for use when the user returns. When a user ultimately does decide to purchase, they proceed to the universal shopping cart checkout 206 where they can choose to add or drop products, add or change method of payment, select shipping options, and so forth. Note, however, that in embodiments where the virtual community is not an online network, but is a network of humans conducting offline interactions, the checkout feature will still be present. As is discussed below, there will be a communications means of some sort, typically internet protocol (IP) based, between the user-generated content and the universal shopping cart, and this communications means would be used as well for checkout.

Once a purchase has been made, the merchant (or merchants; a single checkout can be conducted to purchase products from a plurality of merchants, and indeed from a plurality of content promotions) receives notification of the order and payment arrangements from the service provider 110 that operates the universal shopping cart (step 207; recall that this service provider could in fact be the operator of the virtual community as well, but need not be). Finally, the member from whose content 123 each purchase decision was made receives an endorsement fee or other monetary reward from the service provider 110 in step 208. Again, from a single “browsing expedition” or web session, multiple purchases from multiple content promotions could be made. And the products could be from multiple merchants. Accordingly, each transaction is tracked in the universal shopping cart as a tuple, record, or set of data elements containing at least the buyer's identity, the content creator's identity, and the product's identity (which can be tied to the merchant based on the data provided in step 201).

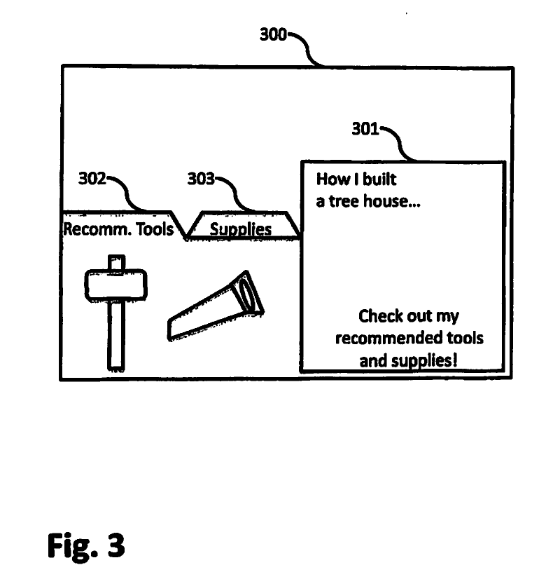

FIG. 3. provides an example of what content containing product promotions according to the invention might look like. In this embodiment, the content 123 is a web page 300 containing user-created text 301. In this case the text describes how a DIY (Do it yourself) project was completed; this might be a common type of posting on a homeowner's social network. Additionally, the creator to the page added two tabs labeled “Recommended Tools” 302 and “Supplies” 303. On these tabs are placed text, tabular data, or (as in the example) images of products that were found useful to the author. It is clear that this is one natural form of mixing user-generated content 123 with product placements (i.e., advertisements). Others who want to replicate the success one author achieves may well want to know what particular tools and supplies were found the most useful, and it would be convenient for such users to be able to click on the items he does not already possess and have them effortlessly shipped to his home in time to start the project on the weekend.

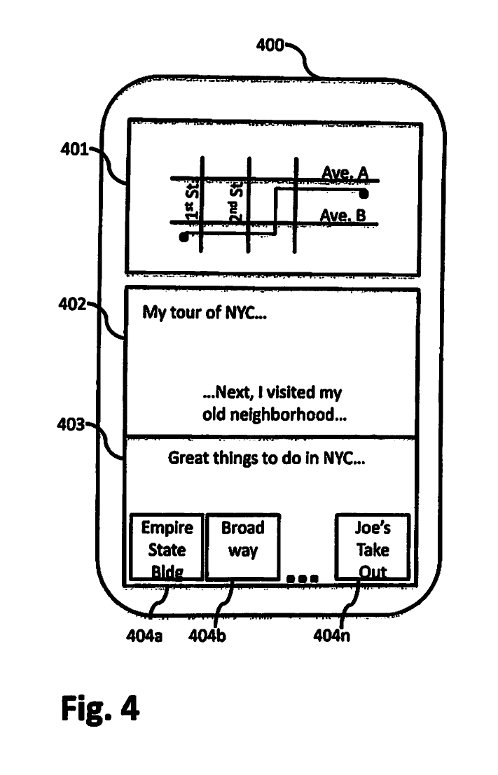

FIG. 4. provides an example of another embodiment of the invention. In this embodiment, user-generated content is viewed on a mobile phone or personal digitals assistant (PDA) 400. A member of a virtual community has created her own content comprising a guided tour of New York City, including a map of the tour as she conducted it 401, a narrative of the tour 402, and a selection of “Great things to do in New York” 403. The items (404a through 404n) are product placements selected by the content creator to enhance the value of her guided tour content by allowing viewers, as they follow her path through the city, to select and purchase additional activities without having to leave her content. Note also that the content creator could leverage the fact that many PDAs and mobile phones today have Global Positioning Systems (GPS) receivers and can track where the user is in the city very accurately. This can be used to move the map as the user walks the tour, but it can also be used to change the promotions offered 403 based on where the user is. Such location-based product promotions within content 123 are an extremely potent form of content-based advertising. While location-based services are emerging rapidly in the marketplace, and in particular while leveraging location information in mobile applications is known in the art, the combination of this capability with the unique embedding of product promotions within user-generated content 123 (the object of the present invention) is new. Each item (404a through 404n) represents a recommendation of a product (or service—these terms should be understood to be interchangeable throughout this specification) by a person whom the user is likely to trust more than a mass advertiser because the user is a member of the same virtual community as the content creator. Thus this location-based advertising example represents an extraordinarily precise targeting of an advertisement, and is thus one for which advertisers will in general be willing to pay a premium.

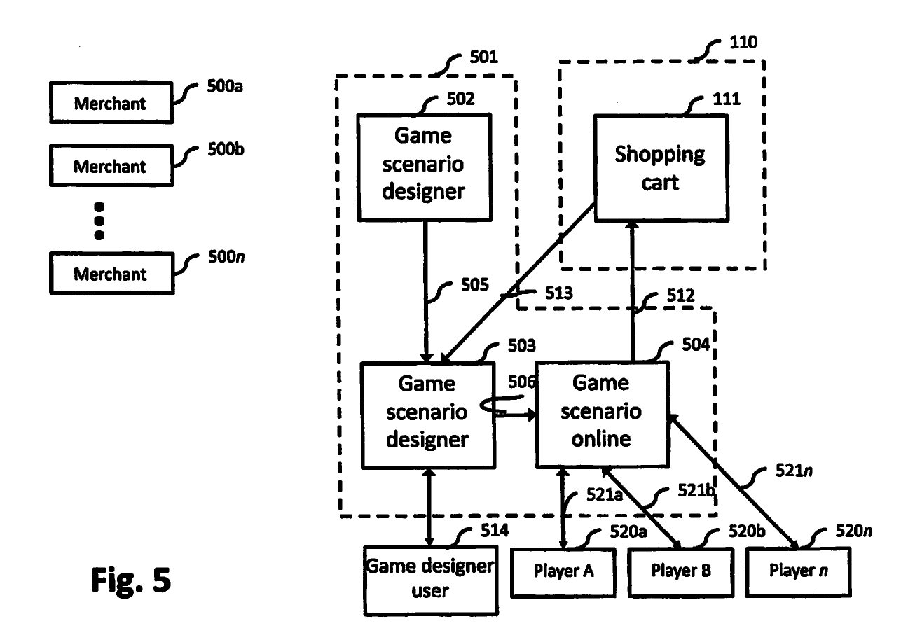

FIG. 5 is yet another embodiment illustrating an exemplary use of the invention to monetize user-generated content 123. Merchants (500a through 500n) make products available, as before, for promotion by members of a virtual community via a universal shopping cart 111. In this case, the virtual community is an online gaming community (514 and 520a through 520n) which shares an interest in games produced by game company 502, specifically the game domain 501. Optionally, the merchants could contract with the gaming company 502 to promote their products in the game domain 501, or they could upload product information directly to the universal shopping cart 111 as before. The gaming company provides a game scenario editor 503 tailored to the domain 501, through the use of which game designer users 514 can design custom scenarios that can be deployed 506 and then viewed online 504 by players (520a through 520n). The game designer user 514 can be a player as well, or she could be a specialist member of the virtual community who designs high-end scenarios full-time. But as in other embodiments of the invention, by gaining the ability to embed product promotion from merchants 500 into her scenarios, the game designer user 514 gains access to a valuable new revenue stream and a means of enhancing game play. One of the benefits the inventors foresee for the monetization of user-generated content 123 is illustrated in this last comment—when advertisements are inserted by trusted members of the virtual community in order to enhance the experience of using the virtual community, the ads are likely to be viewed positively rather than as a burden (which is how people generally view advertising). People are consumers by nature, and they appreciate being well-informed, so when useful information comes to them in a venue they enjoy, from sources they trust, buyers are likely to appreciate sellers for doing them a service. This upending of the traditional view of the role of advertisers as mass manipulators is important. The product promotions placed within their user-generated content by members of a virtual community are likely to not be viewed as advertisements at all by their viewers, but rather as welcome sources of information and hassle-free purchasing. To make this point clear, in this example the products being sold might be game accessories, books, and items that are closely tied to the thematic content of the game, and these are items that players of the game would enjoy seeing in the game; real-world consumption becomes part of the alternate reality (especially when considers virtual worlds, a specialized kind of massively multiplayer online role-playing game that could have promotions added in as shown in FIG. 5).

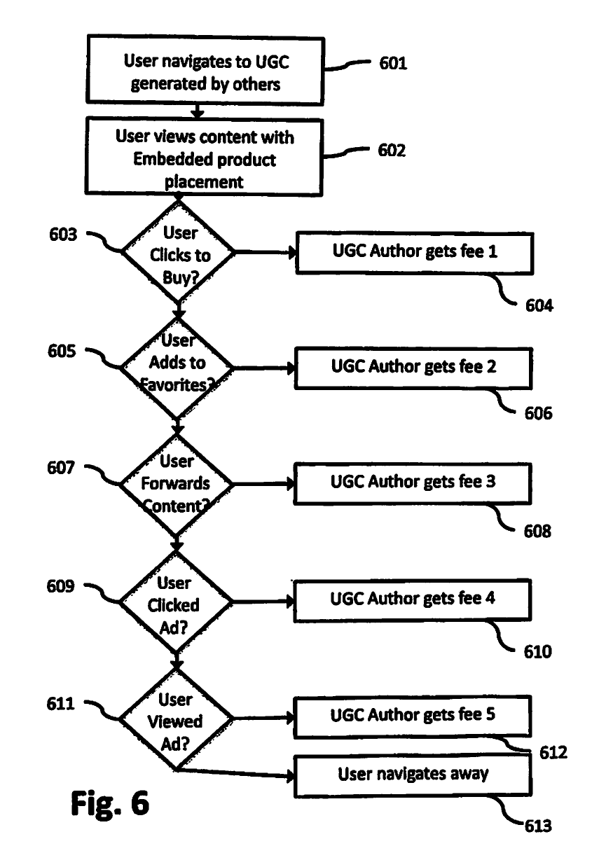

FIG. 6 shows an example of how use of product placements in user-generated content can result in monetization of that content for its creators and for the operator of the virtual community 120. After a user (125a through 125n) navigates 601 to user-generated content created by other users, and selects a page or view that contains product placement text, images or videos 602, then a series of questions can be continuously evaluated until such time as the user leaves the site entirely 613 (although, as noted above, if a user returns later and buys a previously viewed product, then the author would be entitled to some set fee, called Fee 1 604). Typically, this Fee 1 would be variable based on the value of the product sold, although it does not need to be. Other formats might include a fixed fee (for items of generally low cost) or fees based on level of sales achieved by the creating user for the month, or quarter. It should be appreciated that there are any number of ways one might choose to calculate the fee; what is essential here is that the user (and the virtual community site/operator, out of whose fee the creating users' fees are paid in most cases, although again this can be done in several ways according to the invention) gets a monetary reward for selling the product. Similarly, if the user adds an item to his Favorites 605, or otherwise marks it for future reference, a different, generally lower, Fee 2 606 may be paid optionally to the content creator. Similarly, if a user forwards the product to another member of the social network 607, the creator of the content 123 where the product was viewed can optionally be paid a Fee 3 608 by the virtual community operator. In similar fashion, in an exemplary embodiment, when users click on a product placement to view details 609, or when a user simply views a product placement 611, the content creator may optionally be paid Fee 4 610 or Fee 5 611, respectively. It should be understood that these fees are exemplary in nature, and some, none or all of them may in fact be paid, and others not listed could be paid, in order to provide the content creator with an inventive to promote products that are likely to be attractive to the members of the virtual community who are likely to view her content.

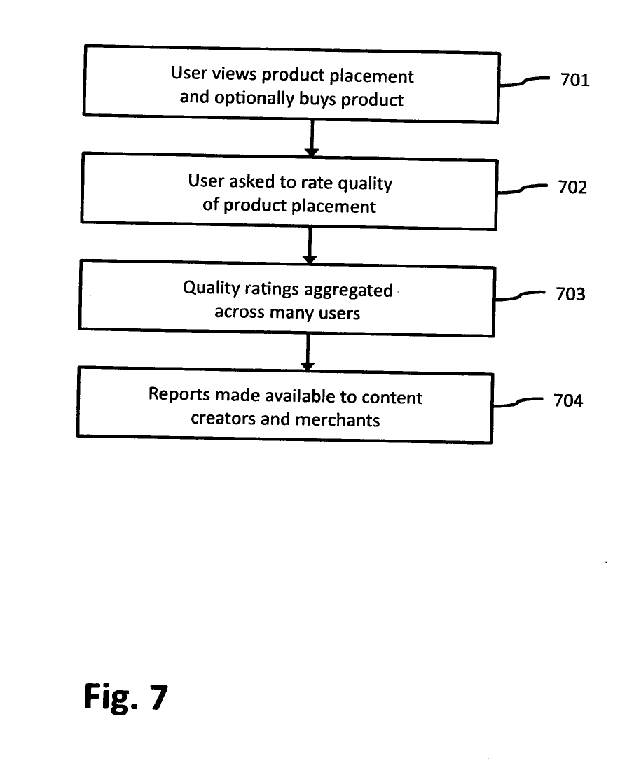

FIG. 7 shows a product placement quality rating process of an embodiment of the invention. It would be extremely useful for a content creator to know which promotions were the most successful, and further to understand whether lack of success is due to lack of interest in the product or, more seriously, due to user discontent with how products are being promoted. Similarly, merchants and optionally virtual community operators have a need to understand how effective their marketing activities into a virtual community are. Merchants may choose to pay more, or to limit availability of certain products for placement to content creators who achieve quality ratings above some minimum threshold. Accordingly, after users view product placements within user-generated content and optionally make purchase decisions 701, users may optionally be asked to rate the perceived quality of the product placement or placements they have just viewed 702. The request to rate quality can be done after every click-through, on a random sample basis, after every purchase, or based on any of a number of sampling techniques well established in the art. Quality ratings provided by users are then aggregated 703 and used to establish overall ratings for each content creator. Ratings can be based on several optional “dimensions”, such as suitability of endorsed or promoted products for the target audience, accuracy of descriptions provided by content creators (if any), quality of products purchased and purchase, payment, and shipping processes, and so forth. Essentially any factor that can contribute to perceived quality, or lack thereof, of product placements, viewing, order and receipt processes, and of products themselves, can be rated in this way. Ratings can then optionally be provided 704 to merchants and content creators. A content creator might use these reports to refine methods of presenting product promotions, or to refine product selections. Merchants can use this data, as mentioned, to refine their marketing efforts through virtual communities. Also, optionally feedback scores can be provided to viewers of content 123 in the virtual community, for example by displaying information such as “this member's quality score is 97%, with 32 responses” when a product placement is selected for detailed viewing. This reputation system is similar to others known in the art, for example on large auction and ecommerce sites; an additional element here is not so much how data is gathered or used but more what the gathered data represents—it reflects the evolving reputations of members of the virtual community as endorsers of products. It is anticipated by the inventors that merchants may well be willing to pay more for promotion of their products by content creators who in effect develop reputations as “product gurus to be trusted” within their communities.

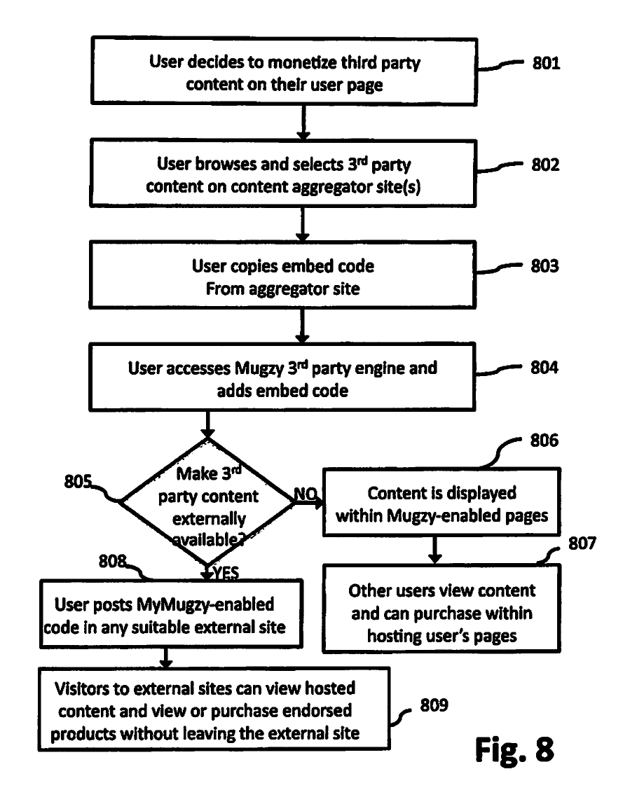

FIG. 8 shows a method, according to an embodiment of the invention, for monetizing third party content. Many users of virtual communities may desire not only to endorse, or advertise, products in their own content 123 as described above, but also to endorse products within or connected with third party content such as is commonly provided by content aggregators such as YouTube®, FlickR®, Revver®, and the like. In an embodiment of the invention, such users decide to monetize third party content on their own pages in step 801. Pages could be profile pages within a virtual community 120, scenarios within a gaming domain 501, personal blogs, personal websites, or any online location under control of the user. Under control here means sufficiently under control of a user to enable carrying out embodiments of the invention, and does not necessarily imply complete control or ownership of the online location by the user. Having decided 801 to endorse products within or in association with third party content, the user in step 802 browses one or more content aggregator sites to select third party content which can be used in conjunction with endorsements of products (or services). This step is exemplary of the underlying step, which is that a user selects some content for display on some location under their control as described above, potentially at least for the purpose of endorsing and possible selling products and services to others. Other examples of content selection include, but are not limited to, selecting content from a storage device such as a local hard drive, a hard drive on an accessible network, a removable “thumb drive”, a published CD or DVD, and the like. Once content is selected, a user then copies embedded code from the content aggregator site in step 803. Such embedded code, as described above, is designed for insertion into online locations provided with a suitable insertion point, much as is accomplished in the art with embedded code for advertising networks. Again, this step is exemplary, as other means can be used within the scope of the invention to enable the embedding of the third party content in online locations under user control. For example, if a user intends to host content from a storage device and runs her own web site, she could add code written for the express purpose of inserting such content directly into her web site source code. Alternatively, readily available software modules, or widgets, that enable streaming media could be inserted into an online location under control of a user, and content could be loaded directly into such a software module directly from a storage device. In step 804, users access a server operated by virtual community 120 or service provider 110 that hosts software that acts as a third party endorsement engine. This software and its associated server allow users to upload the embed code obtained in step 803 and to select products to endorse from among those made available for endorsement by merchants 100. Alternatively, in order to enable endorsement of products in or with third party content, in step 804 users load code obtained in step 803 into a software module provided by a service provider 110, for example the MyMugzy® widget provided by Pure Verticals, Inc. The MyMugzy widget, or equivalent software modules, is adapted to contain code obtained in 803 and to interact with a universal shopping cart 111, thus linking the third party content and access to the universal shopping cart in a single software module that is suitable for inclusion in online documents or locations.

In a subsequent step (805), users of an embodiment of the invention choose whether to make third party content accessible outside of the current online location. Alternatively, when users are conducting monetization of third party content within a virtual community, steps 801 through 804 are performed on a suitable page or in a suitable software module hosted by service provider 110, which as before could either be the operator of a virtual community 120 or could be providing services on behalf of a virtual community 120, and step 805 is the service provider's or virtual community's selection of whether users will be allowed to make third party content accessible outside of the virtual community 120. The decision in step 805 may optionally be made based on specific rules or terms enforced by the owner or aggregator of the content selected in step 802. Such rules or terms may be contractual or may be enforced through the inclusion in embedded code downloaded in step 803 of software routines which prevent redistribution of content beyond the location for which it was originally released. For example, a content aggregator or content owner can embed code which is rendered at the time of the selection in step 802 and which only allows selected content to be hosted at or viewed from the location from which a user selected the content. Alternatively, a content aggregator or content owner could provide a list of online properties or domains within embedded code provided in step 803 to users, and only content hosted at one of the online properties or domains specified in a list so provided would be functional. In another example, a content aggregator or content owner could include code means in embedded code provided to users in step 803 that, when users attempt to view content associated with the embedded code, communicates over a network such as the Internet with a specified service or server connected to the network and requests permission to display the content to the requesting user. In this example, the provision of permission, and possibly the attachment of usage conditions to such permission, can be based on a number of factors that could be included in the request, including but not limited to the identity of the requesting user, the membership status of the requesting user in some group demographic segment, the time of day, and so forth. It will be appreciated that quite sophisticated mechanisms can be established by content owners or content aggregators, or both, to control when and how their content is displayed, and to control whether product endorsements are to be allowed to be inserted into or associated with their content, how those endorsements can be performed, who can endorse products, and what products or vendors can be endorsed. For instance, a content owner could prevent competing content creators from advertising their content to potential buyers from within or adjacent to the content owner's content. If content export is not allowed in step 805, then in step 806 the content is displayed within Mugzy-enabled pages within the virtual community 120 or within the website or domain to which the content was limited in step 805, and in step 807 other users of the virtual community or domain in which the content is hosted view the content and associated product endorsements and can optionally purchase products from within the hosting user's pages or locations. If content export is allowed in step 805, then in step 808 the user posts or uploads embed code for the MyMugzy widget, or equivalent software modules or widgets adapted to contain the embed code from step 803 and suitable product endorsements, to one or more target external sites or online locations adapted to receive such embed code. The embed code can be in JavaScript or any other suitable form that is commonly accepted by online properties such as virtual communities, blogging networks or sites, consumer feedback sites, and the like. Note that the decision in step 805 is not necessarily an either/or decision; in some cases users will be allowed to export the third party content and associated product endorsements and also to host them within the virtual community or service provider or user-controlled location at which the decision 805 was executed. For example, a user may desire to display a video from a favorite coffeehouse musician and endorsements for one or more of the musician's published CDs. The user can do this from her profile page in a social network or other virtual community, for example by following a link provided by the social network and then browsing third party content to find a suitable video. The user can then select products for endorsement, in this case CDs from the favorite musician, using the Mugzy third party engine provided by the social network. Once the third party embed code and product endorsement code is obtained and linked one to the other, the user can add the video for viewing under a “music I have recently found” heading on her Mugzy-enabled profile page within the social network, and she can also obtain the equivalent MyMugzy embed code, which in effect wraps around the full functionality provided on the Mugzy-enabled personal profile page in an embeddable software object that is invoked when the MyMugzy embed code is itself invoked from an external location. She can then post or upload this MyMugzy embed code on her profile pages in one or more additional virtual communities, as well as on her own personal home page and her own personal blog. In fact, the MyMugzy embed code can be embedded in media files provided with insertion points for embedded code and distributed on a CD or removable storage device to particular individuals. Those receiving individuals could then, when playing the content on the CD or storage device at their leisure, view and purchase product endorsements from the endorsing user whenever the viewing is conducted while online (the MyMugzy embed code, like all embed code, requires access over the Internet to one or more locations specified in the embed code; in this case the original virtual community's third party engine). Once MyMugzy code embed code is uploaded to a suitable external web site, virtual community page or other online location (or it is loaded into a suitable network-connected playback device if the code is loaded on a CD or portable storage device), visitors to the external site (or users of the CD or portable storage device) can view the hosted third party content and view and optionally purchase, recommend, rate or comment on products endorsed in or adjacent to the hosted content. In a preferred embodiment of the invention, viewing users do not need to leave the hosted content in order to view or purchase endorsed products; the code necessary to connect back to the universal shopping cart is included in the MyMugzy embed code and the entire viewing, selection and checkout process (or any portion thereof) can be performed from within the control of the MyMugzy widget without leaving the associated third party content.

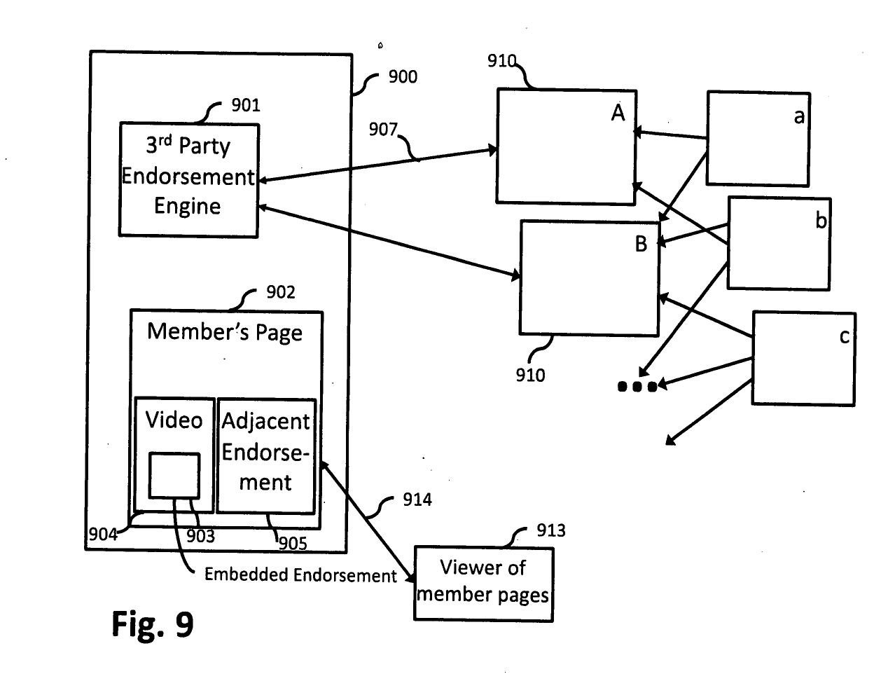

FIG. 9 illustrates a preferred embodiment of the invention in which viewers of a Mugzy-enabled site 900 view third party content while viewing a user's page 902 on the site. The user responsible for page 902 accesses, via a third party endorsement engine 901, third party content available at one or more content aggregator sites 910. Third party content 904 is provided by content creators or owners 911, who optionally upload their content to one or more content aggregation sites 910. Content creators 911 can upload the same content to one or more aggregators, and users of the Mugzy-enabled site 900 can access third party content from one or more aggregators. Additionally, not shown in FIG. 9 but similarly exemplary of the invention, users can access third party content directly from the content creators 911 without the intermediary services of a content aggregator 910. Users responsible for user-managed pages 902 on site 900 access a third party endorsement engine 901 not only to browse and select third party content, but also to interact with a universal shopping cart 111 in order to select products or services for endorsement within 903 or alongside 905 the third party content. In an exemplary embodiment, the third party content is a video 904, and products are endorsed via embedded endorsements 903 which can be inserted at defined insertion points within video 904 or can be viewed by mousing over hot spots in the video window. Hot spots can be made active throughout the length of the video or only during certain portions of the video, as specified by the managing user in the third party endorsement engine 901. Alternatively, endorsements 905 can be deployed adjacent to, or close to, the third party content according to the invention. Visitors 913 to the Mugzy-enabled site 900 may view user-managed pages 902 and in particular they may view third party content 904 that is hosted thereon. While viewing third party content, visitors 913 are optionally shown one or more embedded, adjacent or nearby product endorsements (903 and 905). At any time while viewing the third party content, viewers may elect to click on or otherwise select one or more of the product endorsements in order to view more details about the product or products being endorsed. The additional information, and the ability to select endorsed products for addition to a universal shopping cart, is managed by the third party endorsement engine 901.

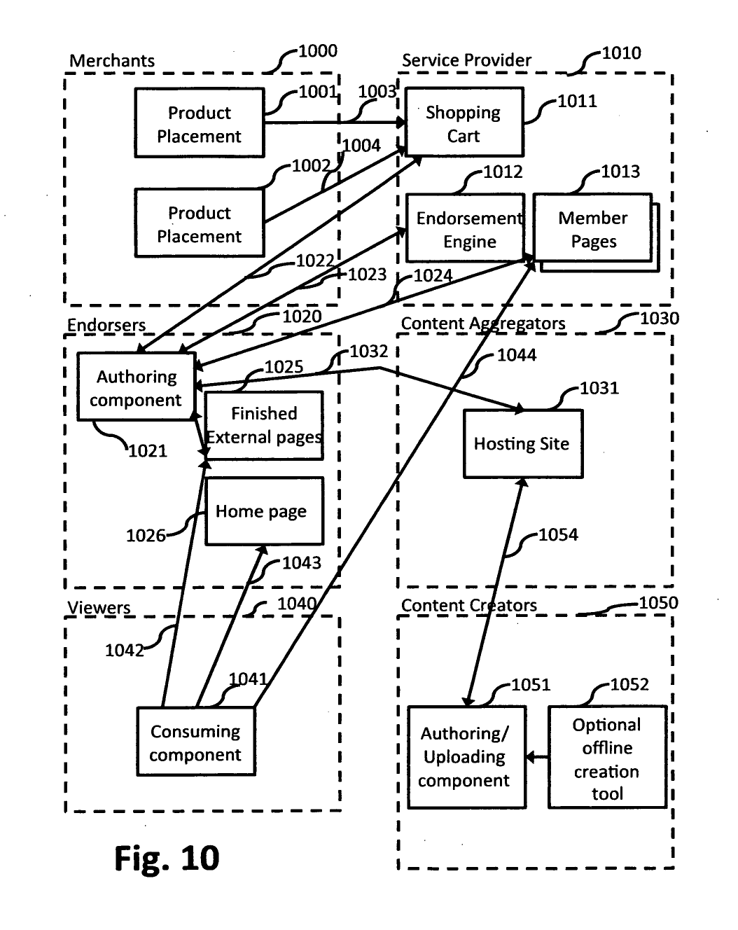

FIG. 10 shows another embodiment of the invention more particularly pointing out an exemplary set of relationships between the various entities involved in monetization of third party content. Not all the entities shown in FIG. 10 are required in every embodiment of the invention, as these entities may interact in various combinations, each leading to the endorsement of merchants' products by users who endorse the products in conjunction with displaying third party content and make possible the purchase of said products by other users while they are viewing said third party content, according to the present invention.

In one such embodiment of the invention illustrated in FIG. 10, a service provider 1010 provides a universal shopping cart 1011 to enable merchants 1000 to make product placements 1001, passing product information about products that are available for sale through the service provider 1010 using interface 1003 to the universal shopping cart 1011, as well as a means for receiving sales transactions 1002 from the universal shopping cart 1011 via another interface 1004. It should be noted that the interfaces 1003 and 1004 need not be separate, but the functions of product placement 1001 and sales transactions 1002 could be carried out over a single interface between the merchant's 1000 systems and the universal shopping cart 1011. This is in general true of the many interfaces described in various embodiments of the invention —the precise arrangement of interfaces is not integral to the invention, but rather the exemplary combinations of functionality enabled to be made through use of the interfaces is essential to the invention.

Service providers 1010 are common on the Internet today and could include one or more of virtual communities, web hosting facilities, internet service providers, and the like. Service providers 1010 provide endorsers 1020 with a variety of services intended to enable them to monetize third party content by endorsing products within or associated with the third party content. Among these services, service providers 1010 provide in an embodiment of the invention the capability to endorsers, using endorsement engine 1012 via interface 1024, to incorporate third party content obtained from hosting site 1031 operated by content aggregator 1030 into user-managed pages 1013, 1025 or 1026. The third party content is generally created separately from the content aggregator 1030, with content creators 1050 creating content according to their goals and desires. Content creators create content optionally using an offline content creation tool 1052 and then uploading the content to one or more content aggregators 1030 using an authoring and uploading tool 1051 that is connected via interface 1054. Alternatively, content creators can use an online authoring and uploading tool 1051 to create content directly online and to submit it to one or more content aggregators 1030 using interface 1054. There are a multitude of well-known offline and online content creation tools, and many content aggregators, and the creation, uploading and hosting (in a content aggregator) of user-generated content is very well known in the art. Service providers 1010 also provide services directly to viewers 1040 of hosted third party content by enabling them, when viewing user-generated pages 1013, 1025 or 1026 using a consuming component 1041, to receive and view product endorsements embedded in or adjacent to third party content that is provided as part of user-generated pages 1025, 1026 or 1013, to view product details, add products to their personal universal shopping cart 1011, and purchase items directly through the MyMugzy or equivalent widget utilizing the services of the universal shopping cart 1011 without leaving the page they are viewing.

While not shown in FIG. 10, which is exemplary but not limiting, endorsers can also obtain content directly from content creators without using the services of a content aggregator 1030, in one of several ways. Content creators often make their content available for download from their own web pages or personal blogs; content from these sources can be downloaded either in the form of media files that can be loaded directly into readily available streaming media hosting software that can in turn be embedded into user-generated pages 1013, 1025 or 1026. Alternatively embed code can be obtained from the content creator directly in a process directly analogous to that used to host content that resides on content aggregator sites. And, as discussed above, there are many means for delivery of third party content directly to endorsers, such as on storage devices or via email.

Endorsers 1020 are thus provided with a rich variety of means of obtaining and hosting third party content and monetizing that content by embedding or closely associating (by adjacent or close placement on user-controlled pages) product or service endorsements. In an embodiment of the invention, endorsers 1020 use authoring components 1021 to generate pages 1013, 1025 or 1026, or combinations thereof. Endorsers connect via interface 1024 from an authoring component to an endorsement engine provided by service provider 1010. Endorsers can obtain third party content directly from content creators 1050 or content aggregators 1030, and obtain embed code or media files which are then uploaded to the third party engine 1012 of service provider 1010. Endorsers may, according to the invention, browse products that are eligible for endorsement or promotion in service provider 1010's environment either by connecting directly to a universal shopping cart 1011 provided by the service provider or by browsing available products in the third party endorsement engine if service provider 1010 chooses to configure the third party monetization system accordingly. Endorsers, after selecting third party content and appropriate content embed code, and after selecting products or services to endorse, receive complete embed code to enable the embedding of a MyMugzy or equivalent software module directly into a finished external page 1025 or a personal home page 1026; alternatively the endorser receives embed code adapted for inclusion in pages belonging to, or managed by, the endorsing user within the service provider's environment (in these cases the use of an embedded software widget is optional, as the endorsement engine, the universal shopping cart and the user page 1013 are all within the domain, or technical and business operating environment, of the service provider 1010). According to an embodiment of the invention, endorsing users 1020 are able to monitor and change their endorsement settings directly through the same user interface embedded in pages 1013, 1025 or 1026 as is used by viewers 1040; since viewers who want to buy products and endorsers who want to modify endorsements will need to be identified before they can conduct such transactions, the universal shopping cart provides an authentication service that is accessed directly by user pages within the service provider environment, or via the MyMugzy or equivalent widget (under control of the embed code) when viewers access product endorsements from external pages 1025 or 1026. Thus endorsing users are able to view, monitor and modify their endorsements and third party content from within the hosting page, and viewers are able to view, rate, comment on, and purchase endorsed products from within the user-managed pages 1013, 1025 or 1026.

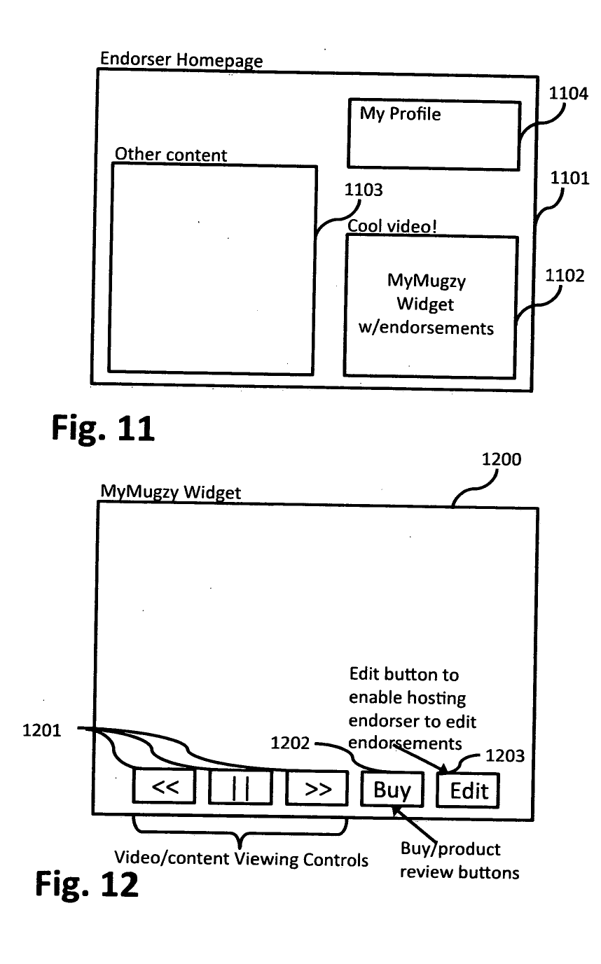

FIG. 11 provides an exemplary illustration of an embodiment of a user-controlled online page, in this case an endorser's home page 1101 (corresponding for example to element 1025 in FIG. 10). Endorsers may put any content they desire on such a page, such as a personal profile section 1104 or other content 1103 that does not use third party content. In an embodiment of the invention, a user can place a third party video on her home page 1101 using the MyMugzy widget 1102. As described above, this or equivalent widgets provide a container for hosting the embed code or media file of the third party content (in this example, a “cool video”), and for hosting the embed code for the product/service endorsement functionality.

FIG. 12 provides a detailed view of an exemplary embodiment of a MyMugzy widget 1200 of the invention. The widget contains either a media file containing third party content or embed code which retrieves the third party content when requested by a viewer, and it contains embed code that connects back to the universal shopping cart 1011 and allows a visiting user to view product or service endorsements, review or comment on endorsements or endorsed products or services, rate endorsements, endorsers, or endorsed products or services, and purchase products or services from directly within the widget 1200. In a preferred embodiment, media viewing control 1201 are provided to allow viewers to view third party content in the widget and to control how that content is viewed (for example, by providing pause, forward and back buttons as shown). Additionally, in a preferred embodiment of the invention, buttons are provided to Buy 1202 endorsed products or services or to Edit 1203 product/service endorsements (this feature is only accessible to the endorsing user). Product or service endorsements may be made visible to the viewer in a number of ways according to the invention, including pop up endorsements that are displayed when a viewer mouses over a hot spot in the widget (hot spots may be visible to prompt the user, or invisible so that users can be encouraged to mouse over items in the video in which they are interested, said items optionally being associated with hidden hot spots that cause an endorsement to pop up). Alternatively, endorsements can, at the discretion of the endorser, be inserted at fixed insertion points in the third party content (although typically this approach requires that the content creator has previously inserted such an anchor or insertion point in his content and made it available to third parties for ad insertion). It will be appreciated that there are many ways in which controls or buttons can be arranged, and many combinations of controls or buttons that can be provided to viewers. Buttons may be always present, or they may only “appear” (become visible) when they are available for use (for example, an edit button may be invisible until and unless a visiting user properly identifies herself as the endorsing user who is hosting the widget, to prevent other viewers from attempting to edit the endorsements or from being confused by the extraneous button).

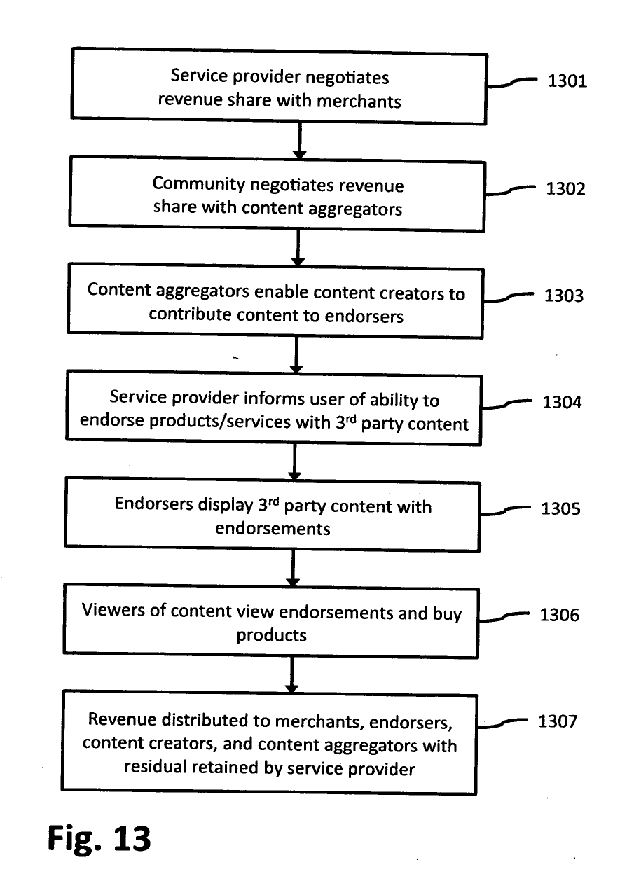

FIG. 13 shows an example of how use of product placements in third party content can result in monetization of that content for its creators 1050, its aggregators 1030, service providers 1010, and endorsers themselves 1020. In an embodiment of the invention, a service provider 1010, in step 1301, negotiates revenue share arrangement with one or more merchants 1010 and stores information pertaining to the agreed revenue share in a third party endorsement engine 1012. In step 1302, the service provider 1010 negotiates revenue share arrangements with one or more content aggregators 1030, and stores information pertaining to the agreed revenue share in a third party endorsement engine 1012. In optional step 1303, content aggregators 1030 enable content creators 1050 to make content available for use by endorsers 1020. This step is optional because the service provider could in an alternative embodiment provide a public online access point to the third party endorsement engine 1012 where individual content creators could agree to one or more available revenue share arrangements provided by the third party endorsement engine and then upload content directly to the third party endorsement engine without the involvement of content aggregators 1030 (or make it available for upload directly by endorsers). In step 1304, the service provider 1010 informs its users that they now have the ability to add third party content to their content pages, and that the abilities to endorse products or services that are described above for user-generated content are now available to them for third party content. That is, the use of third party content and associated product endorsements is promoted within the service provider's user base (and potentially used as an enticement to grow that user base as well as a means to monetize the base). In step 1305, interested users become endorsers, hosting third party content with associated or embedded product placements, promotions or endorsements. In step 1306, viewers of content, whether hosted in endorser pages 1013 within the service provider environment or on external pages 1025 managed by the endorser, or on endorsers' own home pages 1026, view associated endorsements and optionally buy products. In step 1307 revenue generated as a result of product or service sales made is distributed to merchants, endorsers, content creators, and content aggregators as agreed, with the balance being retained by the service provider. It should be recognized that, in addition to paying when sales are made, fees may be generated and shared as described above in description of FIG. 6 for product endorsements in or associated with third party content just as they can be with user-generated content. The key differences between FIG. 6 and FIG. 13 are that the content is generated by a third party rather than the endorser herself, and there are more parties to share any revenue or fees in the case of third party content than in the case of user-generated content; the kinds of fees (and indeed the manner of obtaining ratings, feedback and reputation scores described with reference to FIG. 7 above) are the same whether the content is user-generated or third-party generated, and the scope of the invention should be so considered.

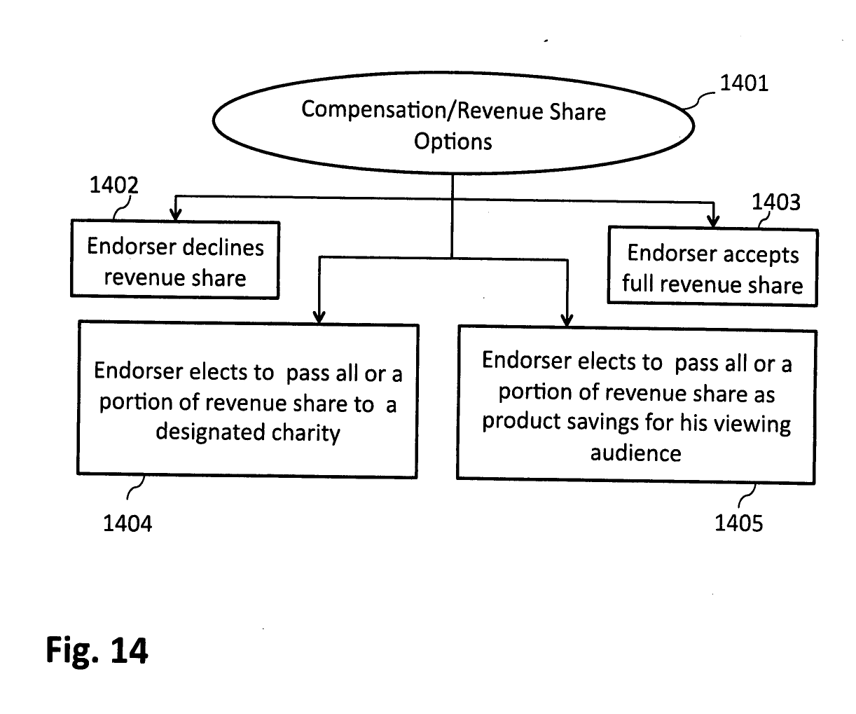

FIG. 14 illustrates examples of possible compensation or revenue share options available to the endorser 1401. In an embodiment of the invention, an endorser may decline revenue share entirely 1402. In this case his reward is advocating for his favorite brand and there is no monetary compensation. Alternatively, an endorser may elect to accept a full revenue share (monetary compensation) 1403 as previously agreed upon with merchant and service provider 1301. In other embodiments of the invention, an endorser may pass all or a specific portion of his monetary revenue share to one or more designated charities 1404. System approved entities such as non-profits and charities would be available for the endorser to select from within the system. In this case an endorser tells a brand what charity to donate his share to. In an embodiment, an endorser who designates all or part of his compensation to go to charity is granted loyalty points or other, non-monetary, recognition rewards as compensation while his preselected charity benefits monetarily. Another possible scenario in this flexible compensation model would be for an endorser to elect to pass all or a portion of his revenue share to his viewing audience in the form of a discount on purchased products 1405. In this case a discount would be applied to viewers of his page who purchased endorsed products. For example assume an endorser elects to pass 50% of his revenue share; for the purpose of this example further assume the 50% share for a product is $2.00. The price of the endorsed product is now discounted by $2.00 to viewers who make a buying decision from the endorser's page. The endorser also receives $2.00 in compensation. In other embodiments content creators, content owners, virtual communities or any others who may be due to receive a revenue share may also elect to allocate their share flexibly. For example they may elect to pass all or a portion of their revenue share to one or more preselected charities or to pass it on as product savings for their viewing audience in the form of a discount. In this embodiment these allocations are all executed automatically within the Universal Shopping Cart or MyMugzy widget.

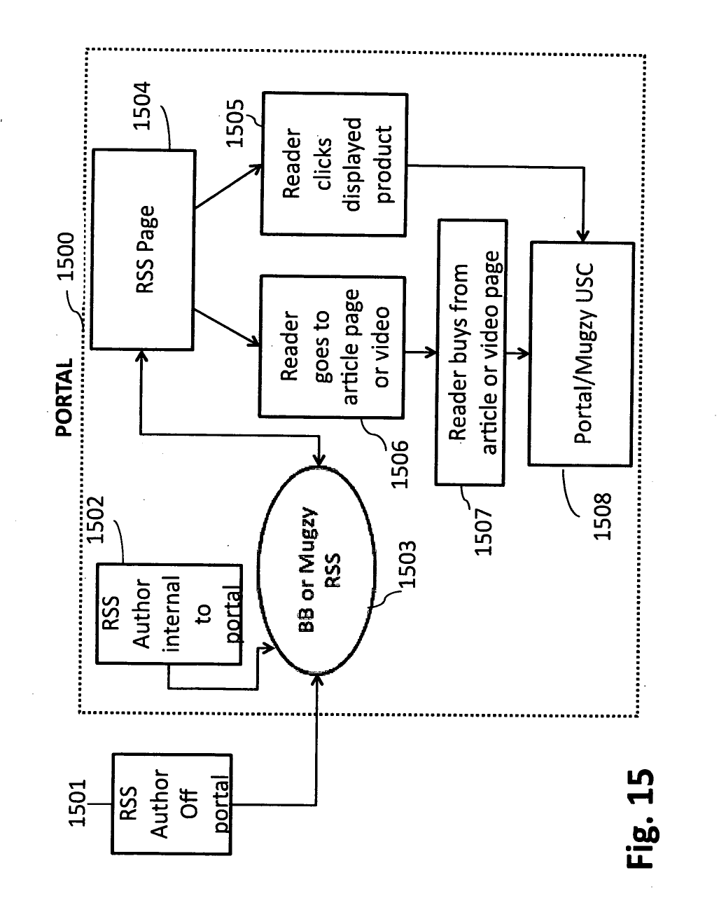

FIG. 15 illustrates the use of the RSS standard technology to enable the syndication of endorsements along with associated content from within a virtual community or web portal 1500. Content authors can be located away from, or “off”, the virtual community or web portal 1501 or internal to the virtual community or web portal 1502. In one embodiment, authors register with a virtual community or web portal and then take MyMugzy to their own web page or web site, as described herein. In another embodiment, authors use a virtual portal's hosted MyMugzy 1503 to publish, also as described above. In an embodiment of the invention, a toggle switch on MyMugzy allows an RSS publication option. Authors publish content and specify products to endorse and can either use merchant supplied promotions (ads) or they can provide their own endorsing content. These endorsed products are displayed on authors RSS page 1504. If a user accesses the content from an RSS reader such as Google Reader or any other RSS client, any linked endorsements will be retrieved along with the author's content. In this embodiment when a viewer buys directly from an RSS page 1505, he will be directed to the portal's Mugzy universal shopping cart (USC) checkout page 1508. In another embodiment a viewer goes to a content page 1506 from an RSS reader page. Content page 1506 is MyMugzy enabled and supports various content such as video, slide shows and text endorsements. If a viewer buys from this content page, the check out is self-contained in MyMugzy USC 1508.

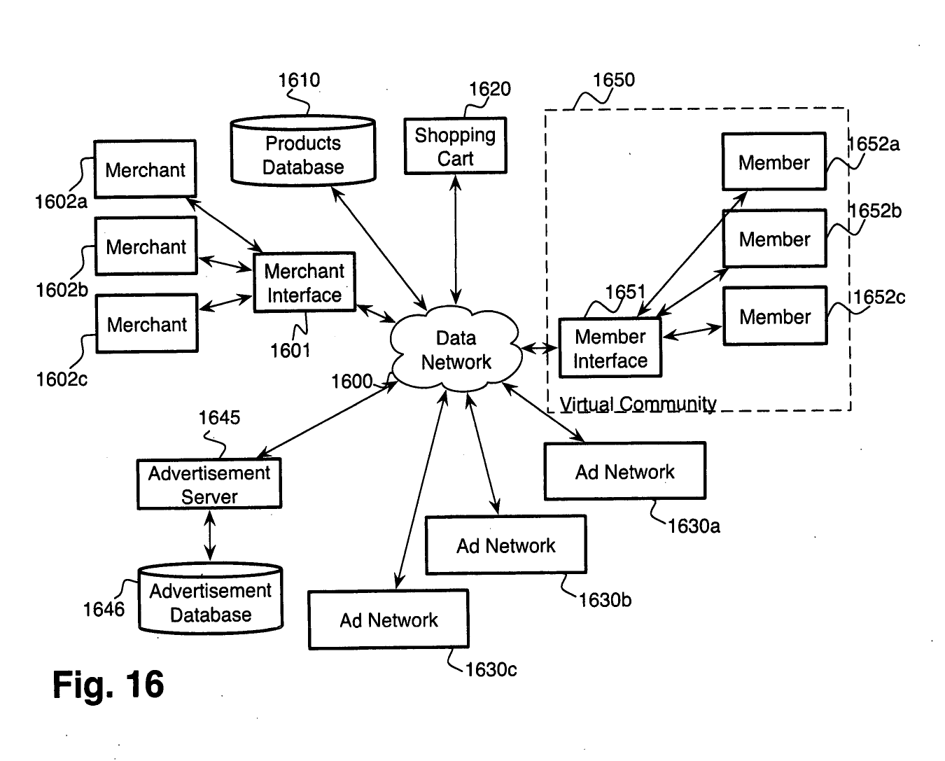

According to a preferred embodiment, and referring to FIG. 16, a system for creating and distributed interactive online advertisements is disclosed. Data network 1600, as before, comprises one or more packet-based data networks, either wired or wireless, that collectively provide a network adapted to allow communications between the various software components illustrated in FIG. 16. It should be noted also that exemplary software components can, using methods well-known to those having ordinary skill in the art of web-based applications, operate in a variety of hardware configurations. In some embodiments, each software component operates on its own dedicated computing device, such as a network-attached server computer or a personal computing device, while in other embodiments one or more software components operate together on a single hardware platform. In some cases, software shown as a single component in FIG. 16, such as shopping cart 1620, may in fact be deployed in a loosely coupled distributed architecture across a plurality of intercommunicating general-purpose server computers. The components illustrated in FIG. 16 serve as examples of different functional elements that together comprise an illustrative embodiment of the invention, without regard to their particular physical deployment in any specific instance.

According to the embodiment, a plurality of merchants 1602a-c, using merchant interface 1601, enter information pertaining to one or more products available from each merchant for sale online. Data pertaining to products is stored in products database 1610, which is adapted to store data pertaining to products available for sale from a plurality of merchants 1602a-c. Merchant interface 1601 is, for example, a web service interface operating on a web-connected server, which receives requests from the plurality of merchants 1602a-c. It should be noted, however, that according to the invention merchant interface 1601 could be any interface that is adapted to allow merchants 1602a-c to interact with products database 1610 via a data network 1600. In some embodiments, members 1652a-c of virtual community 1650 may also, using member interface 1651, enter information pertaining to products they wish to make available for sale. As with merchant interface 1601, member interface 1651 is commonly a web services interface, although it need not be so; what is required is a web-based interface allowing web-connected members 1652a-c to interact with products database 1610. For example, a user who is a member 1652a of virtual community 1650 may desire to sell a number of items online using the invention, and accordingly enters data pertaining to products in products database 1610 using member interface 1651.

Once a merchant 1602a has entered product data into products database 1610, one or more advertisements may be uploaded by the merchant 1602a to advertisement server 1645. Advertisements may be videos or simply audio recordings, of a form suitable for playing using one or more commonly-used online media formats, such as MPEG, AVI, WMV, HTML 5, or the like. Various media formats are supported in the art for online viewing using one or more commonly available browsers (such as Firefox™, Opera™, Safari™, or Internet Explorer™, to name only a few of the more common browsers), and according to the invention any such publicly viewable formats can be used. Essentially, if a format can be used in the art today (or in the future) for non-interactive advertisements, it may be used for interactive online advertisements, according to the invention without limitation.

It will be appreciated that once a merchant 1692a-c or a member 1652a-c has entered product information into products database 1610 and has uploaded or selected one or more advertisements to or within advertisement server 1645, then it would be desirable for the merchant 1602a-c or member 1652a-c to associate one or more products with the advertisements so that, as viewers view the advertisements, they are able to browse information pertaining to the one or more products and to purchase the products without having to click through the advertisements to go to an advertiser's landing page. In general, merchants 1602a-c or members 1652a-c interact via merchant interface 1601 or member interface 1651 to associate specific products with specific locations (or times) within specific advertisements, in order to enable users who later view the advertisements to receive a visual indication that a product is available to be viewed or purchased, the indication occurring at the specified locations or times within the advertisements. This combination of an online advertisement such as those already well-known in the art, and information about selected products (generally including information needed to enable purchase of the products) into an integrated unit is referred to herein as an interactive online advertisement.

Techniques are currently well-known in the art for embedding “embed code” within multimedia objects that are viewable or consumable online, for example by placing embed code for a self-contained video object within a text-based web such as a social network home page or a blog, so that the video is embedded in the text and the two are viewable as an integrated multimedia object within a browser or other viewing means. According to the invention, merchant interface 1601 and member interface 1651 enable an editing user, when viewing an advertisement or content element such as a video, to drag product promotional items onto a timeline of the video, so that when a viewing user views the video, the user is shown the product promotional information when the applicable time period of the video occurs (determined by where on the video's timeline the product promotion was dropped). According to the invention, embed code used to create interactive commerce-enabled advertisements includes a code or set of data that enables a viewing user's browser to connect to shopping cart 1620 so that a user, when viewing an interactive commerce-enabled advertisement, is able to add desired products to a personal shopping cart 1620 and even to check out, all without leaving the interactive advertisement's location.

Once an interactive commerce-enabled advertisement has been created, it can be used in lieu of a conventional online advertisement interchangeably. Because modern browsers already know how to handle embed codes, using a variety of technologies such as cascading style sheets (CSS), dynamic HTML (DHTML), Ajax, or HTML 5 (there are others, but this list illustrates the point), interactive commerce-enabled advertisements may be displayed and interacted with anywhere a conventional online advertisement could be placed. In a preferred embodiment of the invention, interactive commerce-enabled advertisements are uploaded to one or more advertising networks 1630a-c for display on various web properties. Since advertising networks operate by acquiring large numbers of web locations to which they can propagate ads, and by monitoring user traffic on the sites containing those insertion sites, they are able to target advertisements using a large number of targeting techniques well-established in the art. Furthermore, advertising networks have several well-established means for sharing revenue with host sites (that is, sites that make “real estate” available to the advertising network for the insertion of targeted advertisements), so that sharing in revenues generated by advertisement views and click-throughs by viewers of the advertisements is easily accomplished. But, as mentioned before, in advertising techniques currently known in the art, a user must leave the hosting site's page when clicking on an advertisement, generally by being automatically taken to an appropriate landing page controlled by the advertiser; with an interactive commerce-enabled advertisement, users will be able to browse products and purchase them from within actual advertisements without leaving the hosting site's page and its associated content.

In some embodiments, advertisement server 1645 is a general-purpose content aggregation server or service, such as YouTube™. Rather than uploading advertisements, merchants 1602a-c or members 1652a-c select one or more content items for use as interactive advertisements, and associate products with the content in the manner just described.

Shopping cart 1620 also enables anonymous interaction with interactive online advertisements, according to an embodiment of the invention. Anonymous interaction may be accomplished in various ways, according to the invention. For example, a cookie can be left on a viewing user's machine that contains a code such as a globally unique identifier (GUID) that uniquely identifies a particular anonymous shopping cart 1620 associated with the particular browser. Then, as the anonymous browsing user moves from one interactive commerce-enabled advertisement to another across the web, subsequent additions to the user's shopping cart can be correctly entered based on the shopping cart identifier stored in the cookie. Another approach known to enabling anonymous shopping is to track a network address (such as an internet protocol address) associated with the browsing user's machine. Then, when the user later views another interactive commerce-enabled advertisement and wishes to interact with her cart (by adding a product associated with the later advertisement, or by editing a list of products “in the cart”), a lookup based on the network address of the computer on which the browser making the request is operating is conducted by shopping cart 1620 to identify the previously used shopping cart associated with that network address. In this second method, if there is no previous shopping cart associated with the requesting network address, a new shopping cart instance is created by shopping cart 1620, and the new instance is associated with the network address. When a user who has elected to use an anonymous shopping cart elects to check out (generally by purchasing items in the shopping cart), the user will be prompted to provide payment and shipping information, which is used to process the user's purchase. A checking out anonymous shopping cart user may optionally be prompted to consider enrolling as a member of a shopping cart service or virtual community so that, in future shopping sessions, the user will no longer be anonymous. If a user declines such a prompt, and chooses to remain anonymous, then the data provided to execute the user's purchase is stored solely for the purposes of conducting the single transaction and maintaining a record of the transaction, and the user will remain anonymous in that, in the future, any shopping carts the user invokes will be treated as anonymous.

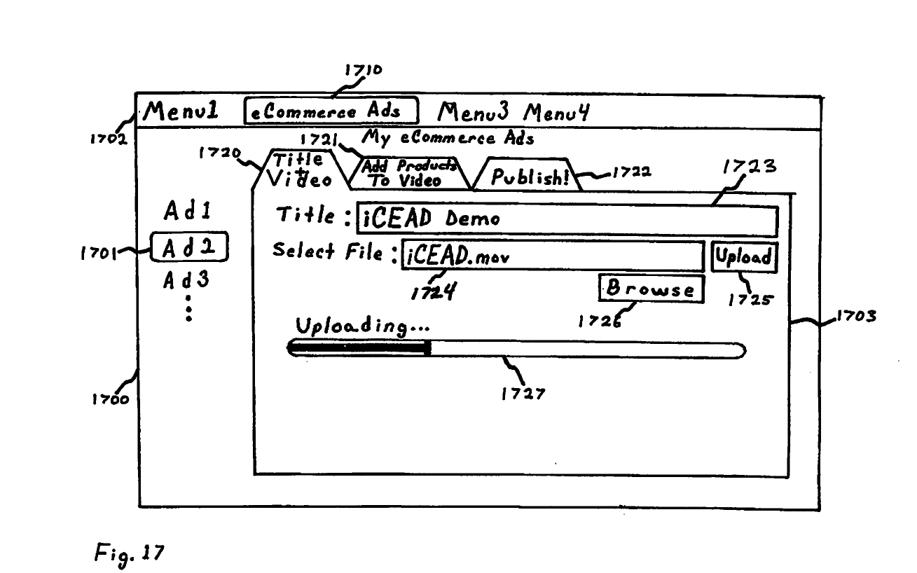

In a preferred embodiment of the invention and referring to FIG. 17, merchants or other users make product promotional information available for viewing in association with online videos or other multimedia content using a web-based user interface 1700. In some embodiments, user interface 1700 comprises a menu bar 7120 or equivalent, as if well known in the art. In some embodiments, advertisements 1701 are displayed in a side bar or other web-page location; such advertisements may be delivered by the site operator providing web page 1700 or by one or more advertising networks. In the exemplary embodiment shown in FIG. 17, one of the menu items 1710 on menu bar 1702 allows a user to select “eCommerce Ads” or equivalent to cause to be displayed a frame 1703 or other web design element adapted to allow a user to upload videos or other multimedia content, associate product promotional information with one or more time slots in the video or other multimedia content, and publish the resulting interactive online commerce-enabled advertisement from within frame 1703 or similar web design element. It should be noted that a person having ordinary skill in the art of web page design will appreciate that the user interface elements shown in FIGS. 17-19 illustrates only one among ways exemplary ways that such functionality can be exposed to users, and is intended to clearly illustrate one embodiment of the invention rather than to limit the scope of the invention.

According to the embodiment, in a first step corresponding to title tab 1720, a user (taken during descriptions associated with FIGS. 17-19 as being either a merchant or a consumer) is presented with a data entry frame or window 1703 that provides a text entry means or data entry field 1723 for entry of a title by which the video or multimedia content will be referred to. A second data entry field 1724 is provided for entry of a filename that corresponds to a storage location where the video or multimedia content is located, generally but not necessarily on the same machine as the browser application that renders web page 1700 to the user. In most embodiments, a Browse button 1726 is provided to allow a user to cause a navigation window or frame to be presented, by means of which the user can navigate to the location of the file containing the video or multimedia content in order to select. When Browse button 1726 is used, upon selection of a file in the resulting navigation frame or window, the filename of the selected file is automatically populated in data entry field 1724, thus providing an alternative mode of specifying the filename of the video or multimedia content. It will be understood by people having ordinary skill in using web pages that there are many variations on the selection process just described that are known in the art, any of which may be used to select the video file or other multimedia content, according to the invention. An Upload button 1725 is provided to allow a user to direct web page 1700 to upload video file or other multimedia content corresponding to a filename entered in data entry field 1724; on clicking Upload button 1725 when an appropriate filename is entered in data entry field 1724 (that is, one corresponding to an actual video or other multimedia file), the file is uploaded to the server that is hosting web page 1700. Alternatively, files could be uploaded by prior configuration to a different server without departing from the invention. While a file is uploading, upload progress (generally but not necessarily in terms “percentage of file size uploaded”, trending from 0% at start to 100% when the file is fully uploaded) is displayed by Upload Progress bar 1727. There are, of course, many variations in how web sites display task completion progress, any of which could be used in place of Upload Progress bar 1727 without departing from the scope of the invention.

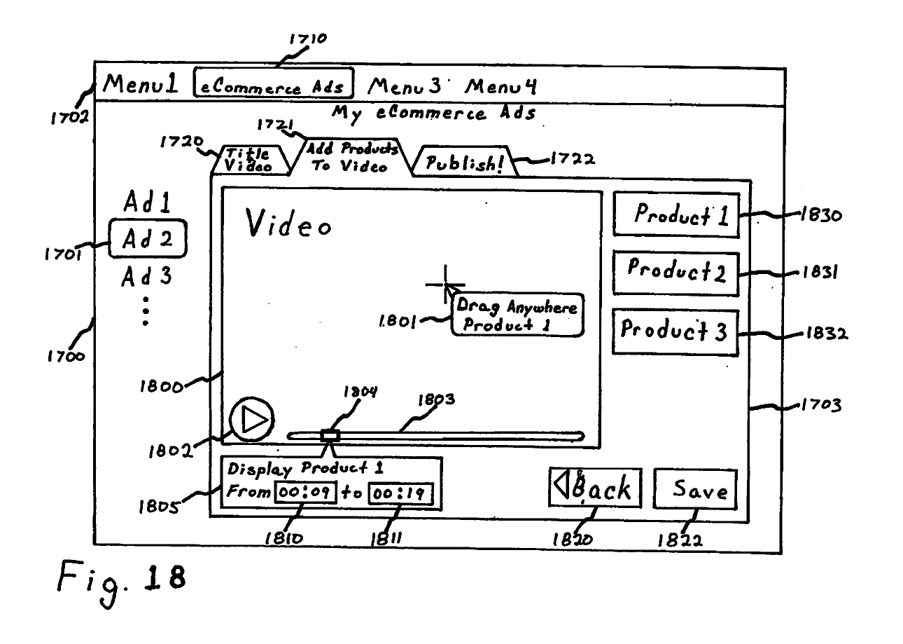

In a second step, after entry of a user-selected title and uploading of a video or other multimedia content file, and referring to FIG. 18, a user clicks on title tab 1721 to change the view in frame 1703 to one designed to allow addition of product promotions to selected video or other multimedia content. When tab 1721 is selected, frame 1703 displays a video viewer 1800, and various additional controls to enable necessary user interactions. Video viewer 1800 displays the beginning of the video file or other multimedia content selected and uploaded as described above, and a play/pause button 1802 which is used by a user to start and stop video (or other multimedia content, such as for example audio) playback. Additionally, a timeline bar 1803 is provided to display to the user the currently playing point within the video, and to allow placement of promotional time windows 1804, which are segments of time within the video at which product promotions will automatically appear. In most embodiments, a Back button 1820 is displayed, activation of which causes a user to go back to the user interface associated with the Title and Video tab 1720 (described with reference to FIG. 17), and a Save button 1822, which causes all data and selections made by the user to be saved to the server that provides web page 1700. Finally, one or more products, for example Product 1 1830, Product 2 1831, and Product 3 1832, are displayed (generally by displaying the name of the respective product) in close proximity to video viewer 1800.

According to the invention, when a user has loaded a video and selected tab 1721, the video is automatically loaded and may be played in video viewer 1800. While the video is playing, or while it is paused, a user may select a product from the products displayed close to the video viewer 1800 (in the exemplary embodiment shown in FIG. 18, these are Products 1-3 1830-1832). Upon selection, a product placement tool 1801 appears over the video displayed in video viewer 1800, to allow the user to drag the cursor associated with product placement tool 1801 to a desired physical location within video viewer 1800 (generally, if a user drags the product placement tool 1801 outside of the boundaries of video viewer 1800, it will disappear and in effect the user will have canceled the product selection which caused the product placement tool 1801). When a user selects a product 1830-1832 and drags the product placement tool 1801 to a point in video viewer 1800 and releases the product placement tool 1801 (typically by releasing a mouse button which was held down while dragging), the product promotion is placed at the corresponding location in video viewer (that is, it will appear at that location, in front of the playing video, during the time period when the product placement is active during video viewing). The times of product placement are controlled by the placement of product placement time window 1804 on video timeline 1803. Generally, when a product 1830-1832 is selected for placement, a product placement window is automatically created and placed on video timeline 1803 at the current video playback time (since product placements can be made while viewing the video, to assure that the appearance of the product placement corresponds to a desired time reference point within the video). In some embodiments, once created, a product placement window 1804 is “draggable” along the video timeline 1803, so that a user can simply drag the product placement time window 1804 to a more desirable time reference in the video. Whenever a product placement has been selected and is activated (that is, while the product placement tool 1801 and product placement time window 1804 are active), product display configuration window 1805 is displayed to allow manual editing of the start time 1810 and stop time 1811 of the associated product placement. In preferred embodiments, product placements can be added while a user is actively viewing a video in video viewer 1800, so that, when a desired point in the video occurs, the appropriate product 1830-1832 can be selected, the product placement tool 1801 can be used to position the product placement, and either the product placement time window 1804 or the product placement configuration window 1805 can be used to adjust the start time 1810 and stop time 1811 of the product placement. Note that, if product placement time window 1804 is dragged, the values in product placement configuration window 1805 will automatically change, and conversely if either of the values in product placement configuration window 1805 is changed, the position or the size (width), or both, of product placement time window 1804 is automatically adjusted to reflect the new values. Users may place, and adjust, more than one product placement for any given video, and the product placements may in fact overlap in time; when this occurs, during the period of overlap both product placements would be visible in front of the playing video. Note though that product placement configuration window 1805 and product placement tool 1801 are only visible for one product at a time, after that product 1830-1832 has been selected, and then until either the Save button 1822 or the Back button 1820 is pushed, or another product 1830-1832 is selected.

According to preferred embodiments of the invention, a user may review the results of her actions by playing the video loaded into video viewer 1800 after editing one or more product placements. At each start time 1810 associated with a product placement, the appropriate product placement appears over the video at the location previously selected using product placement tool 1801, and when the corresponding stop time 1811 is reached for the product, the product placement will disappear.

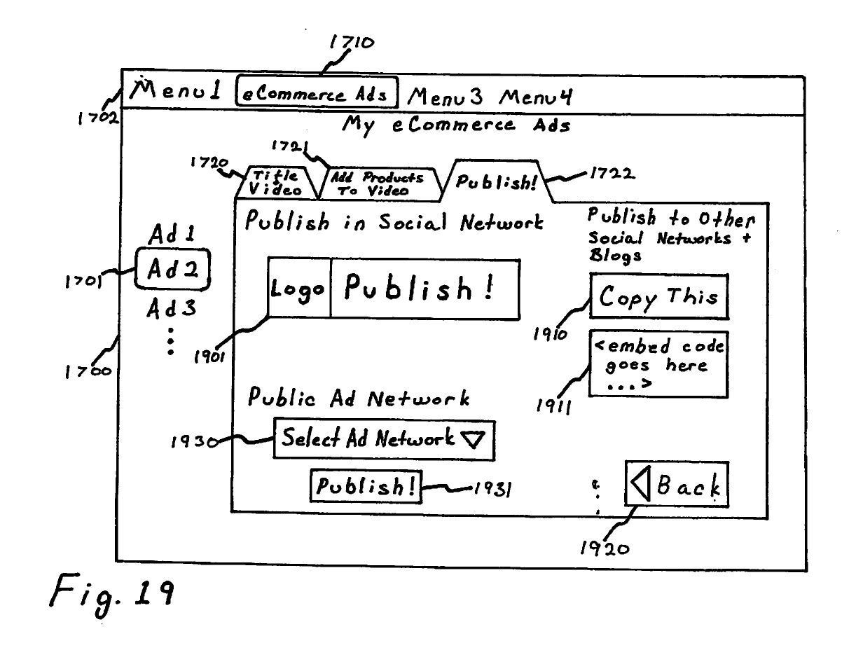

Once a user has made all desired product placements, and has saved them, and referring to FIG. 19, the user selects Publish tab 1722 and various publication options are displayed on web page 1700. As before, Back button 1920 is provided in embodiments of the invention to allow user navigation to previous steps in the process outlined herein, in order to provide full flexibility to users. According to a preferred embodiment of the invention, three options are presented to users to enable them to publish online interactive commerce-enabled advertisements. In one option, a user can publish her interactive advertisement to her social network home page, by clicking on social network publication button 1901. For example, if a user desired to publish an online interactive commerce-enabled advertisement to his Facebook™ page, he would press social network publication button 1901, which would cause either an automatic login to Facebook™, if the user had granted permission and established login credentials with Facebook™ before, or a Facebook™ login page would appear. In either case, after login credentials have been verified, the interactive advertisement would be placed on the user's Facebook™ page automatically. In a second option, users are presented with the ability to publish an online, interactive, commerce-enabled advertisement to other social networks, blogs, or similar online locations. According to the embodiment, embed code, or code intended to be embedded into third-party web locations such as blogs or social network pages, is generated and displayed in code window 1911. Normally users will not edit embed code in window 1911, although in some embodiments advanced users are given this capability. In most embodiments, a Copy button 1910 is provided; when clicked, the embed code displayed in code window 1911, whether or not it was edited by the user, is automatically copied to a predetermined storage location within the user's computer (typically, it is copied to a clipboard managed by the user's computer). Then, when the user navigates to an editing program such as a blogging tool, he can paste the copied embed code directly onto a third party's web page, effectively adding the commerce-enabled advertisement to the target web page. A third option is presented to users, according to the embodiment. Users may use advertising network selection tool 1930 to select an advertising network, and then click on Publish Button 1931 to publish an interactive, commerce-enabled advertisement to an advertising network. For example, a user may desire to allow Google AdWords™ to determine where to display a given interactive commerce-enabled advertisement, and so would prepare the advertisement as described above, then select Google AdWords using advertising network selection tool 1930 and press Publish Button 1931, whereupon a message is sent (generally using publicly-available applications programming interfaces, or APIs, made available by each advertising network such as Google™) to the selected advertising network, and the interactive commerce-enabled advertisement is sent to the advertising network for display by the network. While the three exemplary options described here can be used to publish interactive advertisements online, other similar methods known in the art could be used as well; what is new is the packaging of interactive, commerce-enabled product placements within videos or other multimedia content so that the combined package can be disseminated and displayed in the same way as videos not enhanced according to the invention. To the advertising network, an interactive, commerce-enabled advertisement is not necessarily treated any differently than any other video or multimedia advertisement.

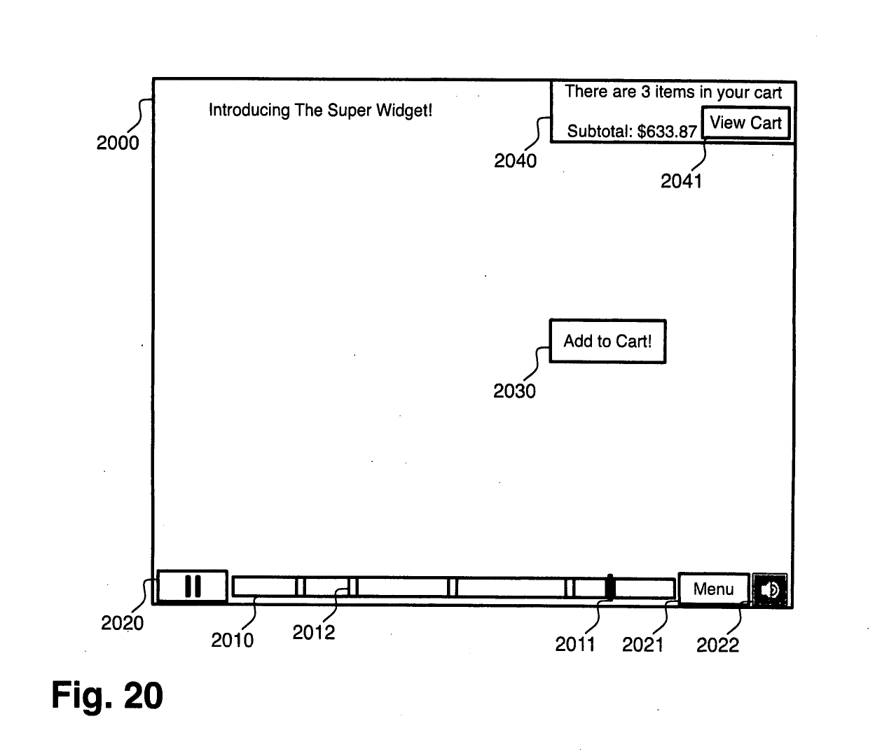

FIG. 20 illustrates an interactive commerce-enabled advertisement 2000 according to an embodiment of the invention. In general, interactive commerce-enabled advertisement 2000 resembles a typical online advertisement, but with a number of additional features that enable interactivity and the conduct of commerce from within the advertisement without any need for a user to navigate to a landing page. Typically, an online interactive commerce-enabled advertisement 2000 will comprise a frame containing advertising content. Advertising content can take the form of a banner advertisement, but more typically will take the form of a video advertisement with embedded audio. According to the embodiment, an interactive commerce-enabled advertisement 2000 is augmented by one or more controls that are visible as needed to enable desired interactivity. For example, a pause/play button 2020 such as is commonly provided in the art may be provided to allow a user to pause video or audio playback, and to resume or stop playback, as needed. Similarly, a Mute button 2022 may be optionally provided to allow a user to mute audio from the advertisement, or to unmute it (typically, mute functionality is provided via a toggle button). In some embodiments, a Menu button 2021 is provided to allow a user to activate a menu of additional interaction options. In some embodiments the interactive commerce-enabled advertisement 2000 is a static image or banner with an associated audio file, such that a viewer hears a recorded audio message (and can control it via pause/play button 2020) while viewing an image or banner. In some embodiments, users are provided with an “Add to Cart” button 2030 which, when clicked, adds the item being advertised to the user's shopping cart. Typically, an “Add to Cart” button appears each time a product is activated during a particular time slot within a playback session of interactive commerce-enabled advertisement 2000, and disappears when the product is deactivated. Activation and deactivation occurs at start times 1810 and stop times 1811 configured in product promotion configuration window 1800. Additionally, some embodiments provide a shopping cart status summary 2040 and a “View Cart” button 2041 which, when clicked, brings up (that is, makes visible in the user's browser, either by causing navigation to a new web page or by popping up or otherwise displaying a status frame or window to the user) a shopping cart review page that allows the user to review items in her cart, add, edit, or delete them, and optionally to proceed to a “check out” page. It should be noted that the functions of shopping carts are well established in the art, but delivering the benefits of a shopping cart from within an interactive commerce-enabled advertisement 2000 without causing or requiring navigation away from the content page in association with which interactive commerce-enabled advertisement 2000 is displayed. In a preferred embodiment of the invention, a video or audio timeline bar 2010 is displayed as part of, or associated with, an interactive commerce-enabled advertisement 2000, and a progress marker 2011 is displayed to indicate to viewing users what point in the video or audio playback is currently playing. Optionally, one or more product placement markers 2012 may be displayed on the video or audio timeline bar 2010 to indicate to users where they can expect product promotional information to appear (that is, when one or more product promotions will be activated).

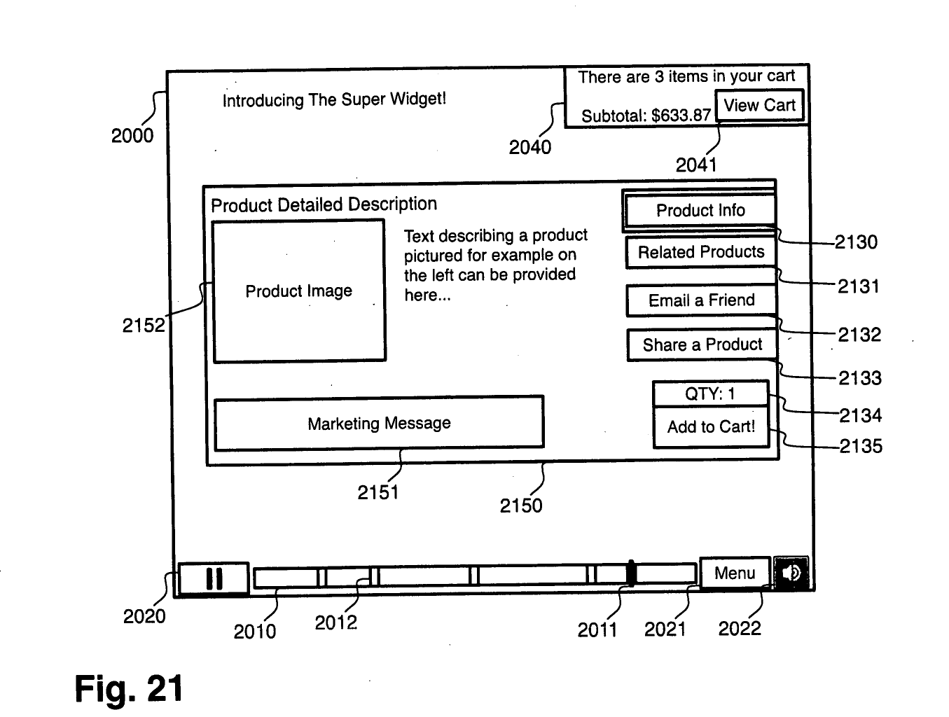

FIG. 21 illustrates an interactive commerce-enabled advertisement 2000 in which a user has “moused over” the advertisement, causing a series of menu options 2130-2133 to be displayed within a menu window 2050. That is, the exemplary interactive commerce-enabled advertisement shown in FIG. 21, when a user moves her mouse over it, displays a menu window 2150 in its foreground. In FIG. 21 a menu option 2130 associated with “Product Info” is selected, as indicated for illustrative purposes in FIG. 21 by the presence of a background border (any other method of indicating to a user that a particular menu option 2130-2133 has been selected may be used as well). Some menu options 2130-2133, such as “Product Information” 2130, “Related Products” 2131, and “Share a Product” 2133 are only relevant when a product promotion is active, such as when, for example, progress bar 2011 coincides with one or more product placement markers 2012, indicating that a current playback time is greater than a start time 1810 and less than a stop time 1811 of at least one product placement marker 2012. Some menu options 2130-2133, such as for example “Email a Friend” 2132, are not associated with any given product being promoted (for example, if a user selects “Email a Friend” 2132, in most embodiments an email window containing a link to, or copy of, an entire interactive commerce-enabled advertisement 2000 would opened for the user, allowing the user to enter emails addresses of one or more “friends” to whom they wish to send the advertisement 2000, without highlighting any one particular promoted product).

According to a preferred embodiment, when a user selects menu option “Product Info” 2130, information pertaining to a particular product is displayed. In most cases, the product about which information is displayed is the product that is active (as described above), although if more than one product is active, the most recently activated product might be selected, or all active products might have information displayed. In some embodiments, if the “Product Info” 2130 option is selected when no product is active, then product information from the most recently active product is displayed (if any product had by then been activated), or the next product due to be activated might be displayed. Any of these methods, or any others that might be desired, can be used to select which product or products from among all those associated with a given interactive commerce-enabled advertisement 2000 without departing from the invention. According to the embodiment, a product image 2152 is displayed, along with text describing the product, and potentially a marketing message 2151 pertaining to the product, its manufacturer, or otherwise desirably arranged in proximity with information about the product. In some embodiments, a Quantity data entry field 2134 and an “Add to Cart” button 2135 are also displayed, to allow users to easily add a specified number or quantity of displayed products to be added to her shopping cart.

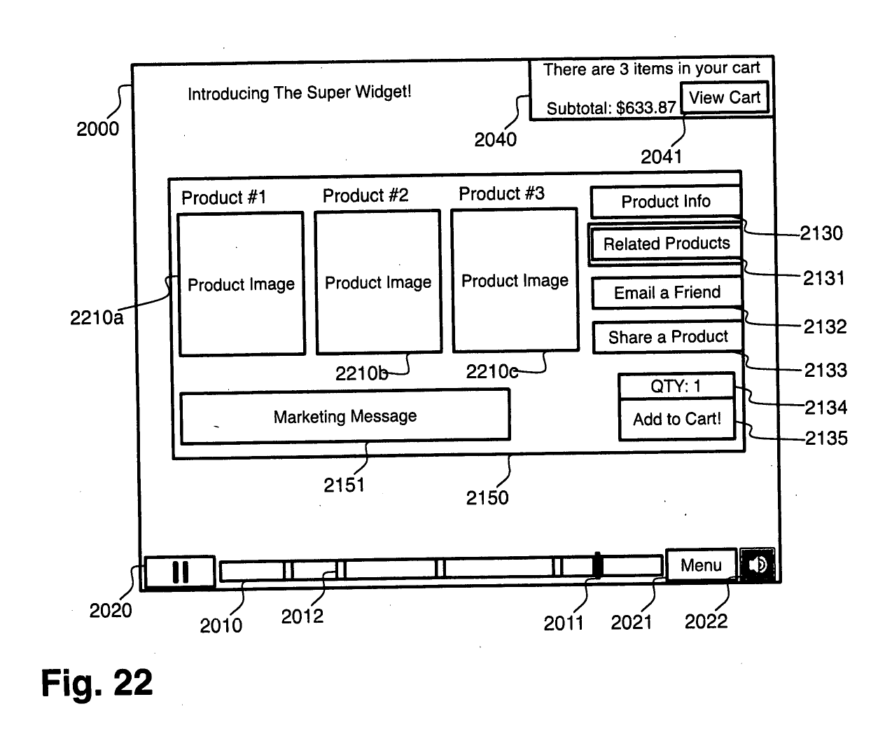

FIG. 22 illustrates an exemplary display resulting when “Related Products” menu option 2131 is selected. As mentioned with reference to FIG. 21, there are several possible means by which a base product, with respect to which related products are to be displayed, is selected, any of which may be used. In menu window 2150, product images 2210a-c of a plurality of related products is displayed. In a preferred embodiment, each product image 2210a-c comprises an active hyperlink, such that when a user moves a cursor over a particular one of product images 2210a-c and clicks or otherwise activates the associated link, menu window 2150 changes to display detailed product information pertaining to the selected product (and “Product Info” menu option 2130 becomes active). As in FIG. 21, marketing message 2151 may optionally be displayed in menu window 2150 when “Related Products” menu option 2131 is selected. Also, quantity data entry field 2134 and “Add to Cart” button 2135 any optionally be displayed, and their functions linked to a particular product based on which product image 2210a-c is active (thus a user could add one or more of each related product from within a single menu window 2150).

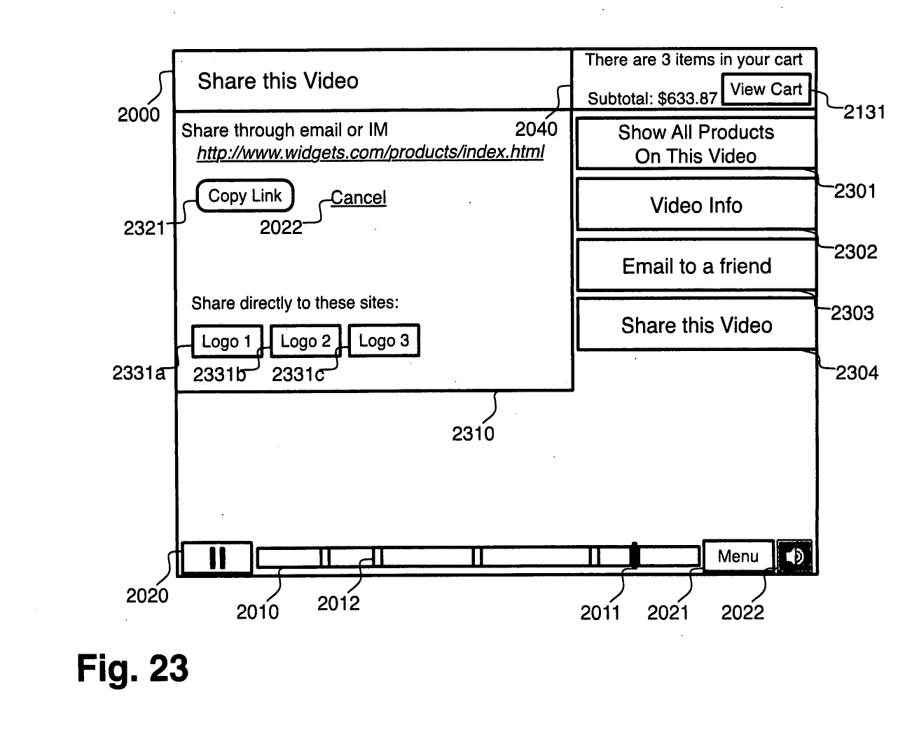

FIG. 23 illustrates an exemplary embodiment of the invention, where menu button 2021 is activated (“turned on”), causing menu options 2301-2304 to be displayed in a foreground of interactive commerce-enabled advertisement 2000. In FIG. 23, “Share this Video” menu option 2304 is selected, and a share video window 2310 is displayed to a user. In the share video window 2310, text is displayed which comprises a link to the video, and a Copy Link button 2321 is provided which, when clicked, selected, or activated, will place a copy of the provided link text in the browsing user's clipboard (a standard feature of all end user operating systems), where it is available for pasting into emails or other applications or content locations, including blogs and other online content locations. In some embodiments of the invention, integration with third-party content sites or virtual communities may already have been conducted by a hosting service provider, and a corresponding set of “Logo buttons” 2231a-c provided, such that when any of the logo buttons 2231a-c is pressed, a copy of the interactive commerce-enabled advertisement 2000 being viewed is sent to the location configured for the applicable logo button 2231a-c. For example, a user could upload an interactive commerce-enabled advertisement 2000 directly to his Facebook™ page by clicking on a Facebook™ logo button 2231a-c according to the invention. Since Facebook™, and many other online content hosters and virtual communities, provides a publicly available application programming interface (API) that allows (among many functions) direct insertion of content from third party locations into subscribers' content pages, the methods used to integrate between interactive commerce-enabled advertisement 2000 and the sites associated with logo buttons 2231a-c are known in the art, and any of the many publicly available APIs for transferring content between locations on the Internet may be used, according to the invention.

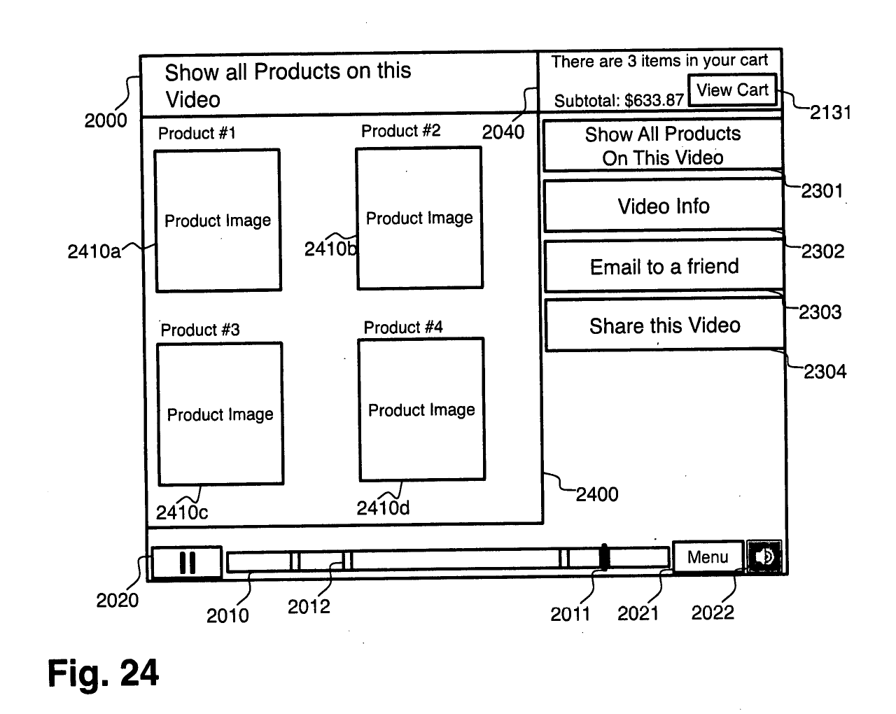

FIG. 24 illustrates the results of activating or selecting “Show all Products on this Video” button 2301, according to an exemplary embodiment (of course, other variations are possible). According to the embodiment, a product display window 2400 is displayed in a foreground of, or on top of, an interactive commerce-enabled advertisement 2000, and product images 2410a-d corresponding to each of the products promoted in association with the underlying advertisement 2000 are displayed within product display window 2400. Each of the products for which at least one product promotion marker 2012 is displayed on video playback timeline 2010 is displayed via a product image 2410a-d.

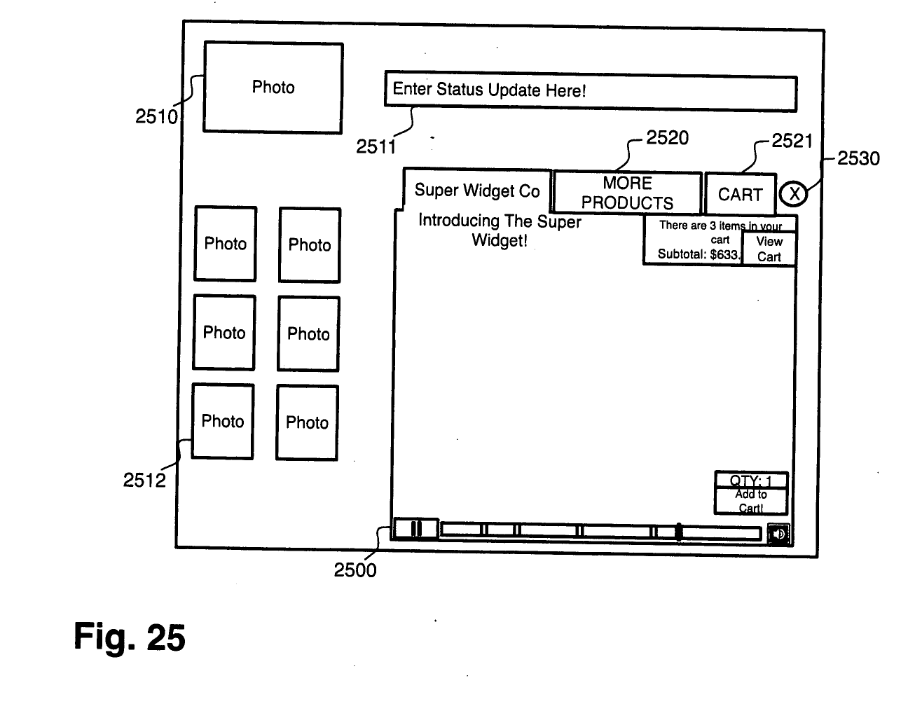

FIG. 25 illustrates an exemplary embodiment of the invention, in which an interactive commerce-enabled advertisement 2500 is displayed as part of, or within, a social network or virtual community user's home page (or any other user page). Commonly, such virtual community pages include a status update field 2511, which allows a user to enter text intended to alert the user's friends and other linked persons to changes in the alerting user's status. Similarly, virtual community users often display a photo 2510 of themselves, and often a plurality of personally relevant photos 2512 are often displayed on a user's virtual community home page. Many virtual communities now possess the capability of hosting applications that are displayed as elements of users' home pages, and interactive commerce-enabled advertisements 2500 may be presented accordingly in virtual communities and social networks, as applications residing in those communities or networks. Interactive commerce-enabled advertisement 2500 is in most respects analogous to interactive commerce-enabled advertisements 2000 not associated with virtual communities. In some embodiments, features such as additional product display and personal shopping carts are made accessible to users via tabs 2520-2521 instead of menus, although either method may be used in stand-alone or social network-resident interactive commerce-enabled advertisements according to the invention, and both variations are accordingly shown and intended as exemplary embodiments. In some embodiments, an icon 2530 is available to users to allow them to “close” the social network-resident application.

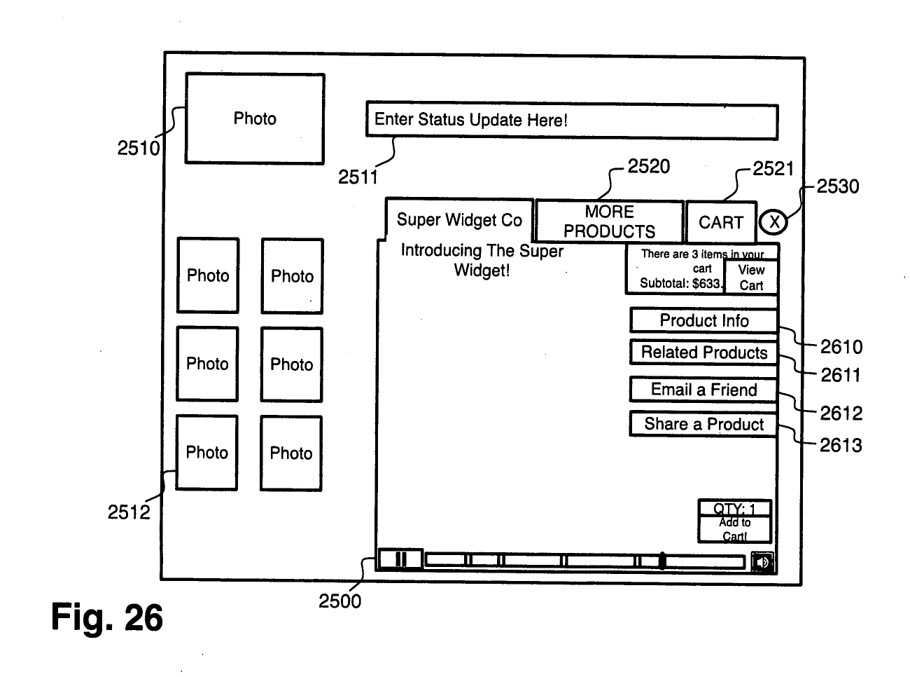

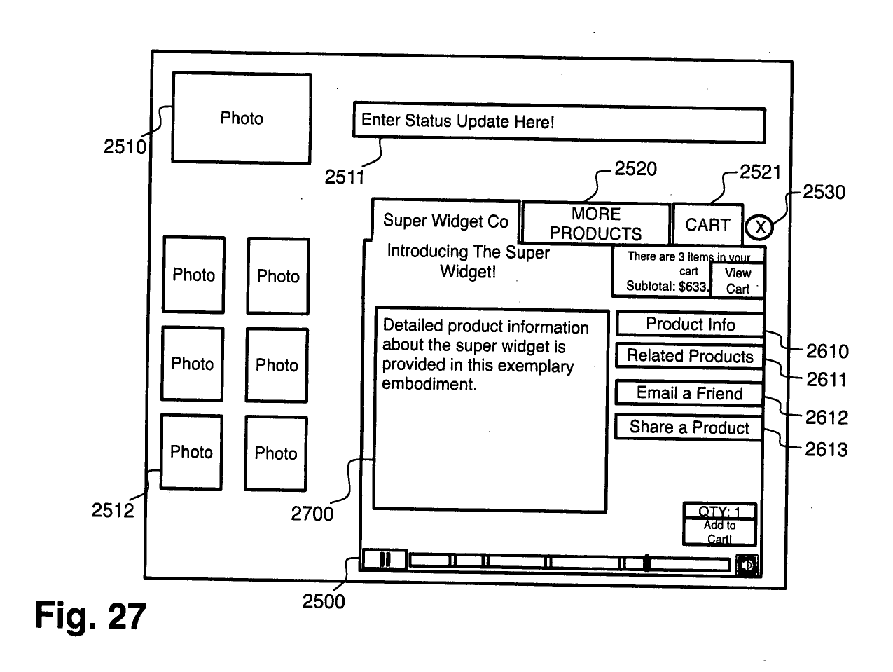

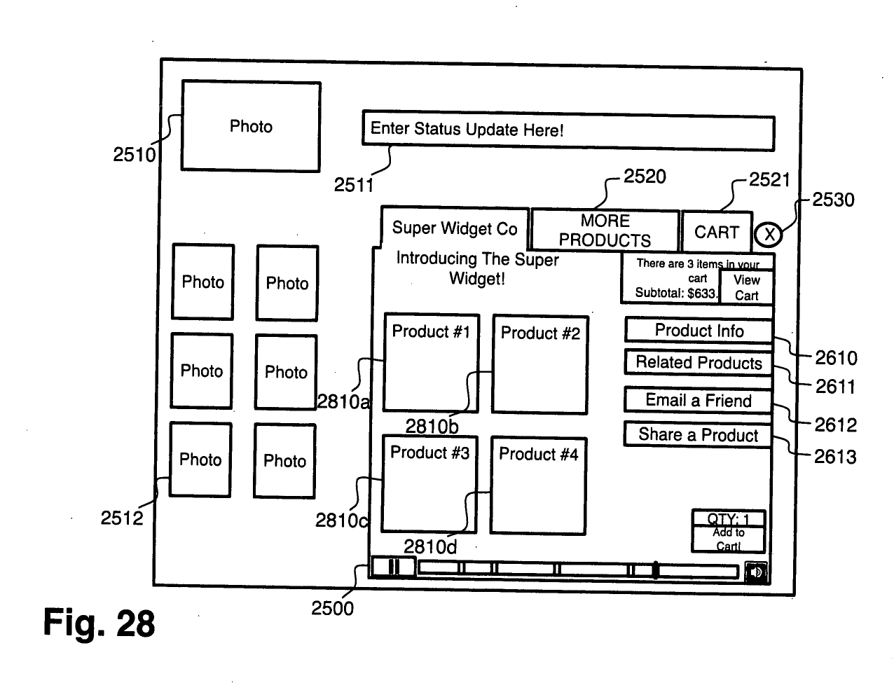

FIG. 26 illustrates the social network-resident interactive commerce-enabled advertisement 2500 of FIG. 25, where after a user's mouse-over of the embedded interactive advertisement 2500, a set of menu options 2610-2613 is displayed, in much the same way as was described with respect to FIG. 21. FIG. 27 illustrates the same advertisement 2500, with “Product Info” menu option 2610 selected (analogous to FIG. 21), while FIG. 28 illustrates the “Related Products” menu option 2611 (analogous to FIG. 22), with product images 2810a-d displayed. As in the previous figures and their accompanying descriptions, it is possible to promote a plurality of products within a single virtual community- or social network-resident interactive commerce-enabled advertisement 2500, and to allow users to view, edit, and buy products from a single shopping cart. Furthermore, as shopping cart functionality is provided by a centrally-located shopping cart server 1620, users are able to add products to their personal (or anonymous) shopping carts from within a plurality of interactive commerce-enabled advertisements, some of which may be associated with a virtual community and others not, and with the various products coming from one or a plurality of merchants, without the users having to manage or even think about the fact that they are in essence visiting many “microstores” seamlessly, without having to conduct many logins.

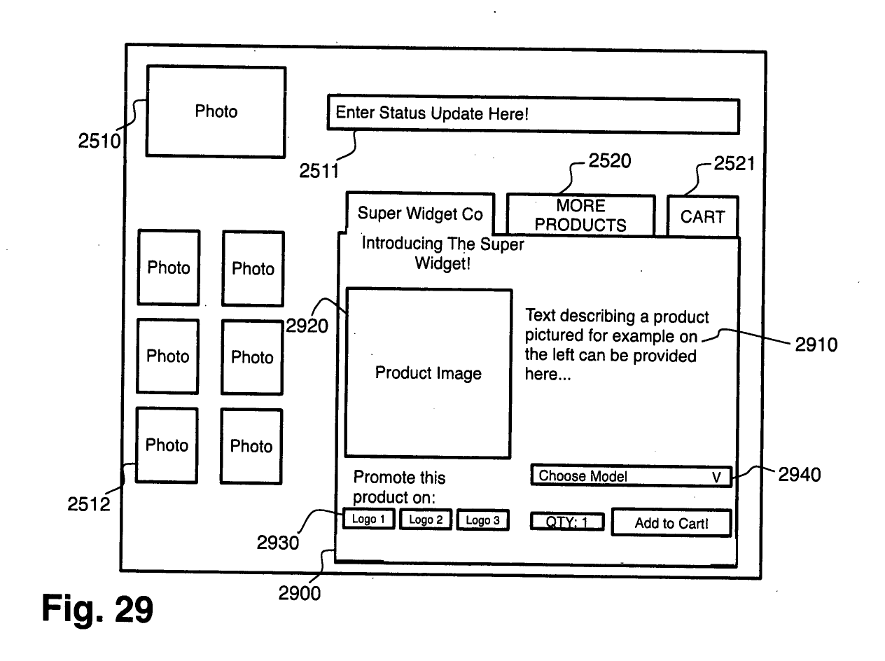

FIG. 29 shows an embodiment of the invention in which, on activation of “close” logo 2530, a dedicated product information window 2900 is displayed. Users are provided with an ability to view related products using “More Products” tab 2520, and are provided access to their shopping cart via “Cart” tab 2521. One or more product images 2920 are displayed in product information window 2900, as well as explanatory text 2910 describing the product. In some embodiments, a model selection tool 2940 is provided, which allows users to select specific models of a product in order to get more precise images 2920 and information 2910. Note that product model selection tool 2940 can in some embodiments be included in non-virtual community interactive commerce-enabled advertisements 2000. Finally, some embodiments allow users to promote a selected product using one or more logo buttons 2930, each of which activates an API associated with the online partner associated with the respective logo, thereby sending packaged information about the selected product to the partner web site specified by the particular choice of logo button 2930.

All of the embodiments outlined in this disclosure are exemplary in nature and should not be construed as limitations of the invention except as claimed below.

What is claimed is:

1. A system for enabling interactive online advertisements, comprising:
a merchant interface software adapted to receive requests over a network;
an advertising server software coupled to one or more networks; and
a shopping cart software adapted to receive requests over a network;
wherein the merchant interface receives requests from a plurality of merchants over a network to upload one or more advertisements to the advertising server, and the merchant interface receives requests from a plurality of merchants over a network to place product-related information at specific points in time within an advertisement; and
further wherein, upon receiving requests for uploading an advertisement and for placing product-related information at specific points in time within the advertisement, the advertising server creates an interactive online advertisement wherein, when a user views a web page with which the interactive online advertisement has been associated, the user is provided with a the advertisement for viewing and, at the specific points in time within the advertisement, the product-related information is provided to the user; and
further wherein, upon receiving a request from a user viewing an interactive online advertisement to place a product about which product-specific information has been provided, the shopping cart server software adds a desired quantity of the product into the user's shopping cart, without the user having to leave the page or the interactive online advertisement within which the user was able to view the product-specific information.
